(19) United States
(12) Patent Application Publication
(10) Pub. No.: US 2026/0101053 A1
(43) Pub. Date: Apr. 9, 2026

(54) METHOD, APPARATUS AND SYSTEM FOR ENCODING AND DECODING A TENSOR

(71) Applicant: CANON KABUSHIKI KAISHA, Tokyo (JP)

(72) Inventors: Christopher James ROSEWARNE, Concord (AU); Thi Hong Nhung NGUYEN, Gladesville (AU)

(21) Appl. No.: 19/114,185

(22) PCT Filed: Jul. 28, 2023
(86) PCT No.: PCT/AU2023/050703

§ 371 Date: Mar. 21, 2025

(30) Foreign Application Priority Data
Oct. 13, 2022 (AU) 2022252783

(51) Int. Cl. H04N 19/33; H04N 19/136; H04N 19/172; H04N 19/42

(52) U.S. Cl. CPC H04N 19/33; H04N 19/136; H04N 19/172; H04N 19/42

(57) ABSTRACT

An apparatus and method for encoding. The method comprises performing data compression for data related to an image, the data compression using a neural network associated with a first set of weights; determining whether a set of weights for the data compression is to be changed; and encoding first information indicating whether the set of weights is to be changed, based on the determination. If it is determined that the set of weights for the data compression is to be changed, the method comprises changing association of the neural network used in the data compression to a second set of weights from the first set of weights; encoding second information indicating the second set of weights; and encoding the data in which the data compression is performed using the neural network with the associated second set of weights.

### REFERENCE TO RELATED APPLICATION(S)

This application claims the benefit under 35 U.S. C. § 119 of the filing date of Australian Patent Application No. 2022252783, filed 13 Oct. 2022, hereby incorporated by reference in its entirety as if fully set forth herein.

### TECHNICAL FIELD

The present invention relates generally to digital video signal processing and, in particular, to a method, apparatus and system for encoding and decoding tensors from a convolutional neural network. The present invention also relates to a computer program product including a computer readable medium having recorded thereon a computer program for encoding and decoding tensors from a convolutional neural network using video compression technology.

### BACKGROUND

Convolutional neural networks (CNNs) are an emerging technology addressing, among other things, use cases involving machine vision such as object detection, instance segmentation, object tracking, human pose estimation and action recognition. Applications for CNNs can involve use of ‘edge devices’ with sensors and some processing capability, coupled to application servers as part of a ‘cloud’. CNNs can require relatively high computational complexity, more than can typically be afforded either in computing capacity or power consumption by an edge device. Executing a CNN in a distributed manner has emerged as one solution to running leading edge networks using limited capability edge devices. In other words, distributed processing allows legacy edge devices to still provide the capability of leading edge CNNs by distributing processing between the edge device and external processing means, such as cloud servers. Such a distributed network architecture may be referred to as ‘collaborative intelligence’ and offers benefits such as re-using a partial result from a first portion of the network with several different second portions, perhaps each portion being optimised for a different task. Collaborative intelligence architectures introduce a need for efficient compression of tensor data, for transmission over a network such as a WAN.

CNNs typically include many layers, such as convolution layers and fully connected layers, with data passing from one layer to the next in the form of ‘tensors’. Splitting a network across different devices introduces a need to compress the intermediate tensor data that passes from one layer to the next within a CNN, such compression may be referred to as ‘feature compression’, as the intermediate tensor data is often termed as ‘features’ or ‘feature maps’ and represents a partially processed form of input such as an image frame or video frame. International Organisation for Standardisation/International Electrotechnical Commission Joint Technical Committee 1/Subcommittee 29/Working Groups 2-8 (ISO/IEC JTC1/SC29/WG2-8), also known as the “Moving Picture Experts Group” (MPEG) are tasked with studying compression technology in various contexts and often in relation to video. WG2 ‘MPEG Technical Requirements’ has established a ‘Video Compression for Machines’ (VCM) ad-hoc group, mandated to study compression for machine consumption and feature compression. The feature compression mandate is in an exploratory phase with a ‘Call for Evidence’ (CfE) issued soliciting technology that can significantly outperform feature compression results achieved using state-of-the-art standardised technology.

CNNs typically require weights for each of the layers to be predetermined in a training stage, where a very large amount of training data is passed through the CNN and a result determined by the network undergoing training being compared to ground truth associated with the training data. Discrepancy between the obtained and desired result is expressed as a ‘loss’ and measured with a ‘loss function’. Using the determined loss, a process for updating network weights, such as stochastic gradient descent (SGD), is performed. Network weight update typically involves a back-propagation of ‘gradients’, indicative of deltas to be applied to network weights, beginning at the output layer of the network and terminating when the input layer to the network, and covering all intermediate, or ‘hidden’, layers of the network. The rate of weight update is scaled by a ‘learning rate’ hyperparameter, typically set to facilitate the training process in finding a global minima in terms of loss (i.e., highest possible task performance for the network architecture and training data) while avoiding the training process becoming ‘stuck’ in a local minima. Becoming stuck in a local minima corresponds to obtaining sub-optimal task performance for the network architecture and being incapable of finding new weight values that could lead to higher task performance. Network weights are repeatedly updated by supplying input data and ground truth data organised into ‘batches’ to iteratively refine the network performance until further improvements accuracy are no longer achievable. An iteration of the entire training dataset forms an ‘epoch’ of training, and training typically requires multiple epochs to achieve a high level of performance for the task. A trained network is then available for deployment, operating in a mode where weights are fixed and gradients for weight update are omitted. The process of executing a pretrained CNN with an input and progressively transforming the input into an output according to a topology of the CNN is commonly referred to as ‘inferencing’.

Generally, a tensor has four dimensions, namely: batch, channels, height and width. The first dimension, ‘batch’, is typically of size one when inferencing on video data and indicates that one frame is passed through a CNN as one batch. When training a network, the value of the batch dimension may be increased so that multiple frames are passed through the network in each batch before the network weights are updated, according to a predetermined ‘batch size’. A multi-frame video may be passed through as a single tensor with the batch dimension increased in size according to the number of frames of a given video. However, for practical considerations relating to memory consumption and access, inferencing on video data is typically performed on a frame-wise basis. The ‘channels’ dimension indicates the number of concurrent ‘feature maps’ for a given tensor and the height and width dimensions indicate the size of the feature maps at the particular stage of the CNN. Channel count varies through a CNN according to the network architecture. Feature map size also varies, depending on subsampling occurring in specific network layers.

The overall complexity of the CNN tends to be relatively high, with relatively large numbers of multiply-accumulate (MAC) operations being performed and numerous intermediate tensors being written to and read from memory, along with reading weights for performance of each layer of the CNN. As such, dividing a neural network into portions allows such implementation of more complex networks even in less capable edge devices.

Feature compression may benefit from existing video compression standards, such as Versatile Video Coding (VVC), developed by the Joint Video Experts Team (JVET). VVC is anticipated to address ongoing demand for ever-higher compression performance, especially as video formats increase in capability (for example, with higher resolution and higher frame rate) and to address increasing market demand for service delivery over WANs, where bandwidth costs are relatively high. VVC is implementable in contemporary silicon processes and offers an acceptable trade-off between achieved performance versus implementation cost. The implementation cost may be considered for example, in terms of one or more of silicon area, CPU processor load, memory utilisation and bandwidth. Part of the versatility of the VVC standard is in the wide selection of tools available for compressing video data, as well as the wide range of applications for which VVC is suitable. Other video compression standards, such as High Efficiency Video Coding (HEVC) and AV-1, may also be used for feature compression applications.

Video data includes a sequence of frames of image data, each frame including one or more colour channels. Where feature map data is to be represented in a packed frame, generally a monochrome frame having luminance only and no colour channels is adequate. When only luma samples are present, the resulting monochrome frames are said to use a “4:0:0 chroma format”.

The VVC standard specifies a ‘block based’ architecture, in which frames are firstly divided into an array of square regions known as ‘coding tree units’ (CTUs). In VVC, CTUs generally occupy 128×128 luma samples. Other possible CTU sizes when using the VVC standard are 32×32 and 64×64. However, CTUs at the right and bottom edge of each frame may be smaller in area, with implicit splitting occurring the ensure coding blocks remain in the frame. Associated with each CTU is a ‘coding tree’ defining a decomposition of the area of the CTU into a set of blocks, also referred to as ‘coding units’ (CUs). Blocks applicable to only the luma channel or only the chroma channels are referred to as ‘coding blocks’ (CBs). A prediction of the contents of a coding block is held in a ‘prediction block’ (PB) or ‘prediction unit’ (PU) and a residual block defining an array of sample values to be additively combined with the PB or PU is referred to as a ‘transform block’ (TB) or ‘transform unit’ (TU), owing to the typical use of a transformation process in the generation of the TB or TU.

Notwithstanding the above distinction between ‘units’ and ‘blocks’, the term ‘block’ may be used as a general term for areas or regions of a frame for which operations are applied to all colour channels.

For each CU, a prediction unit (PU) of the contents (sample values) of the corresponding area of frame data is generated (a ‘prediction unit’). Further, a representation of the difference (or ‘spatial domain’ residual) between the prediction and the contents of the area as seen at input to the encoder is formed. The difference in each colour channel may be transformed and coded as a sequence of residual coefficients, forming one or more TUs for a given CU. The applied transform may be a Discrete Cosine Transform (DCT) or other transform, applied to each block of residual values. The transform is applied separably, (i.e., the two-dimensional transform is performed in two passes, one horizontally and one vertically). The block is firstly transformed by applying a one-dimensional transform to each row of samples in the block. Then, the partial result is transformed by applying a one-dimensional transform to each column of the partial result to produce a final block of transform coefficients that substantially decorrelates the residual samples. Transforms of various sizes are supported by the VVC standard, including transforms of rectangular-shaped blocks, with each side dimension being a power of two. Transform coefficients are quantised for entropy encoding into a bitstream.

PBs or PUs in VVC may be generated using either an intra-frame prediction or an inter-frame prediction process. Intra-frame prediction involves the use of previously processed samples in a frame being used to generate a prediction of a current block of data samples in the frame. Inter-frame prediction involves generating a prediction of a current block of samples in a frame using a block of samples obtained from a previously decoded frame. The block of samples obtained from a previously decoded frame is offset from the spatial location of the current block according to a motion vector, which often has filtering applied. Intra-frame prediction blocks can be (i) a uniform sample value (“DC intra prediction”), (ii) a plane having an offset and horizontal and vertical gradient (“planar intra prediction”), (iii) a population of the block with neighbouring samples applied in a particular direction (“angular intra prediction”) or (iv) the result of a matrix multiplication using neighbouring samples and selected matrix coefficients.

VVC may be used to compress intermediate feature maps from a first portion (a ‘backbone’) of a neural network separated into two portions. In compression, the feature maps from the backbone are arranged into a frame and quantised from a floating-point domain to a sample domain suitable for compression as video data. To reduce the spatial area of the feature maps, additional neural network layers may be implemented at the interface between the VVC encoder and decoder and the intermediate point in the CNN at which the splitting occurs. Training for such additional network layers that may not be suitable for varied and unpredictable encountered feature map data. The training may not result in a CNN having adaptability to operating points of various quality in terms of task performance. The operating point of the encoder and decoder may also vary during operation, with a need to support varying quality levels of the reconstructed tensors to be supplied to the remainder of the network at the decoder side.

### SUMMARY

It is an object of the present invention to substantially overcome, or at least ameliorate, one or more disadvantages of existing arrangements.

One aspect of the present disclosure provides a method of encoding at least a plurality of tensors forming a hierarchical representation for a single frame into a bitstream, the method comprising: deriving a first unit of information from a plurality of tensors forming the hierarchical representation, the plurality of tensors including at least a first tensor and a second tensor, feature maps of the first tensor having a larger spatial resolution than feature maps of the second tensor; encoding, in a first mode, at least the first unit of information into the bitstream; deriving, in a second mode, a second unit of information derived from at least the first tensor; and encoding, in the second mode, the second unit of information and the first unit of information into the bitstream.

Another aspect of the present disclosure provides a method of decoding, the method comprising: performing decoding processing to decode data related to an image from encoded data in which data compression is performed, the decoding performed using a neural network associated with a first set of weights; and decoding first information indicating whether a set of weights for the decoding processing is to be changed, wherein, if the first information indicates that the set of weights for the decoding processing is to be changed, the method further comprises: decoding second information indicating a second set of weights; and changing the association of the neural network used in the decoding processing to the second set of weights from the first set of weights.

Another aspect of the present disclosure provides a non-transitory computer-readable storage medium which stores a program for executing a method of encoding, the method comprising: performing data compression for data related to an image, the data compression using a neural network associated with a first set of weights; determining whether a set of weights for the data compression is to be changed; and encoding first information indicating whether the set of weights is to be changed, based on the determination, wherein, if it is determined that the set of weights for the data compression is to be changed, the method further comprises: changing association of the neural network used in the data compression to a second set of weights from the first set of weights; encoding second information indicating the second set of weights; and encoding the data in which the data compression is performed using the neural network with the associated second set of weights.

Another aspect of the present disclosure provides an encoder configured to: perform data compression for data related to an image, the data compression using a neural network associated with a first set of weights; determine whether a set of weights for the data compression is to be changed; and encode first information indicating whether the set of weights is to be changed, based on the determination, wherein, if it is determined that the set of weights for the data compression is to be changed, the encoder is further configured to: change association of the neural network used in the data compression to a second set of weights from the first set of weights; encode second information indicating the second set of weights; and encode the data in which the data compression is performed using the neural network with the associated second set of weights.

Another aspect of the present disclosure provides a non-transitory computer-readable storage medium which stores a program for executing a method of decoding, the method comprising: performing decoding processing to decode data related to an image from encoded data in which data compression is performed, the decoding performed using a neural network associated with a first set of weights; and decoding first information indicating whether a set of weights for the decoding processing is to be changed, wherein, if the first information indicates that the set of weights for the decoding processing is to be changed, the method further comprises: decoding second information indicating a second set of weights; and changing the association of the neural network used in the decoding processing to the second set of weights from the first set of weights.

Another aspect of the present disclosure provides a decoder configured to: perform decoding processing to decode data related to an image from encoded data in which data compression is performed, the decoding performed using a neural network associated with a first set of weights; and decode first information indicating whether a set of weights for the decoding processing is to be changed, wherein, if the first information indicates that the set of weights for the decoding processing is to be changed, the decoder is configured to: decode second information indicating a second set of weights; and change the association of the neural network used in the decoding processing to the second set of weights from the first set of weights.

Another aspect of the present disclosure provides a system comprising: a memory; and a processor, wherein the processor is configured to execute code stored on the memory for implementing a method comprising: performing decoding processing to decode data related to an image from encoded data in which data compression is performed, the decoding performed using a neural network associated with a first set of weights; and decoding first information indicating whether a set of weights for the decoding processing is to be changed, wherein, if the first information indicates that the set of weights for the decoding processing is to be changed, the method further comprises: decoding second information indicating a second set of weights; and changing the association of the neural network used in the decoding processing to the second set of weights from the first set of weights. Other aspects are also disclosed.

### BRIEF DESCRIPTION OF THE DRAWINGS

At least one embodiment of the present invention will now be described with reference to the following drawings, in which:

FIG. 1 is a schematic block diagram showing a distributed machine task system;

FIGS. 2A and 2B form a schematic block diagram of a general-purpose computer system upon which the distributed machine task system of FIG. 1 may be practiced;

FIG. 3A is a schematic block diagram showing functional modules of a backbone portion of a CNN;

FIG. 3B is a schematic block diagram showing a residual block of FIG. 3A;

FIG. 3C is a schematic block diagram showing a residual unit of FIG. 3A;

FIG. 3D is a schematic block diagram showing a CBL module of FIG. 3A;

FIG. 4 is a schematic block diagram showing functional modules of an alternative backbone portion of a CNN;

FIG. 5 is a schematic block diagram showing a cross-layer tensor bottleneck encoder for reducing tensor dimensionality prior to compression;

FIG. 6 shows a method for performing a first portion of a CNN, constricting using a bottleneck encoder, and encoding resulting constricted feature maps;

FIG. 7A is a schematic block diagram showing a packing arrangement for a plurality of compressed tensors;

FIG. 7B is a schematic block diagram showing a bitstream for a plurality of compressed tensors;

FIG. 8 is a schematic block diagram showing functional modules of a video encoder;

FIG. 9 is a schematic block diagram showing functional modules of a video decoder;

FIG. 10 is a schematic block diagram showing a cross-layer tensor bottleneck decoder for restoring tensor dimensionality after compression;

FIG. 11 shows a method for decoding a bitstream, reconstructing decorrelated feature maps, and performing a second portion of the CNN;

FIG. 12A is a schematic block diagrams showing a head portion of a CNN;

FIG. 12B is a schematic block diagram showing an upscaler module of FIG. 12A;

FIG. 12C is a schematic block diagram showing a detection module of FIG. 12A;

FIG. 13 is a schematic block diagram showing an alternative head portion of a CNN;

FIG. 14 shows a method for encoding tensors into a reduced-dimensionality form; and

FIG. 15 shows a method for decoding tensors from a reduced-dimensionality form into tensors of an original dimensionality.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

A distributed machine task system may include an edge device, such as a network camera or smartphone producing intermediate compressed data. The distributed machine task system may also include a final device, such as a server-farm based (‘cloud’) application, operating on the intermediate compressed data to produce some task result. Additionally, the edge device functionality may be embodied in the cloud and the intermediate compressed data may be stored for later processing, potentially for multiple different tasks depending on need.

Examples of machine task include object detection and instance segmentation, both of which produce a task result measured as ‘mean average precision’ (mAP) for detection over a threshold value of intersection-over-union (IoU), such as 0.5. Another example machine task is object tracking, with mean object tracking accuracy (MOTA) score as a typical task result.

A convenient form of intermediate compressed data is a compressed video bitstream, owing to the availability of high-performing compression standards and implementations thereof. Video compression standards typically operate on integer samples of some given bit depth, such as 8 or 10 bits per sample, arranged in planar arrays.

Tensors typically have the following dimensions: batch size, channel count, height, and width. For example, a tensor of dimensions [1, 256, 76, 136] would be said to contain a batch of one tensor, containing two-hundred and fifty-six (256) feature maps, each of size 136×76. For video data, inferencing is typically performed one frame at a time, rather than using tensors containing multiple frames, resulting in a batch size of one.

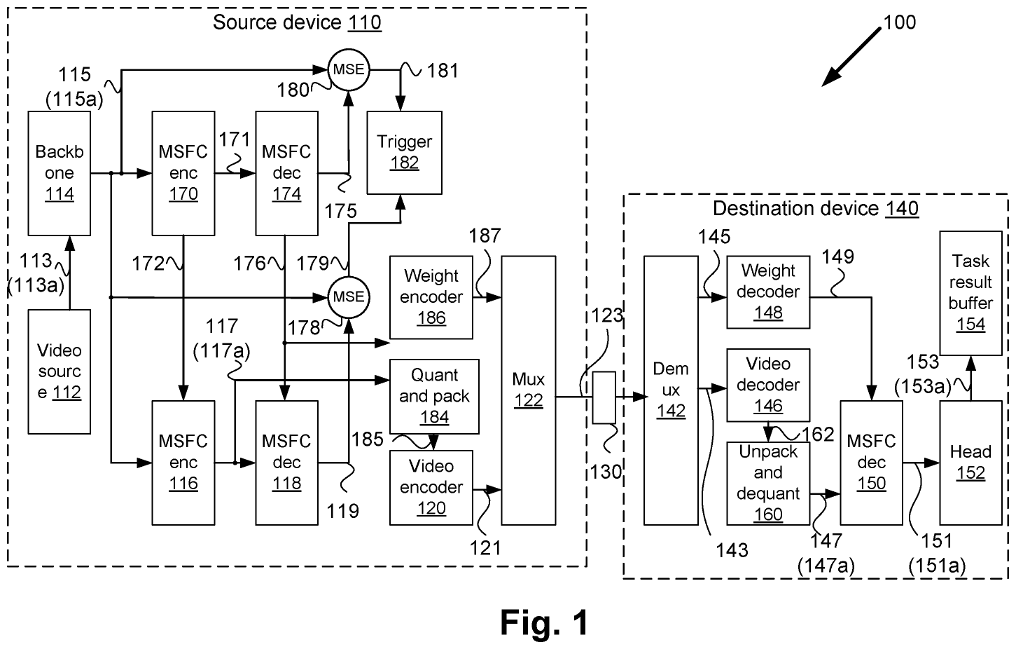

FIG. 1 is a schematic block diagram showing functional modules of a distributed machine task system 100, implementing a neural network divided into two portions, for example, one of which may be in an edge device and the other in a cloud server. The system 100 may be used for implementing methods for decorrelating, packing and quantising feature maps into planar frames for encoding and decoding feature maps from encoded data. The methods may be implemented such that compressed data is encoded to reduce bitrate whilst adapting to changing statistics encountered in the input data. As such, the system 100 provides the ability to perform ‘live’ training (or ‘refinement training’) on incoming tensor data to generate weight updates for the actively used network in the encoder and decoder. Whereas training a task network requires ground truth for the incoming data, refinement training applies only to a portion of the network forming a bottleneck encoder and decoder. A goal of refinement training is to preserve the data passing through with minimal degradation. Accordingly, the tensors at the input to the bottleneck encoder form the ground truth for the output of the bottleneck decoder. Refinement training alleviates the need for predetermined network weights to be trained sufficiently to anticipate all conceivable input data.

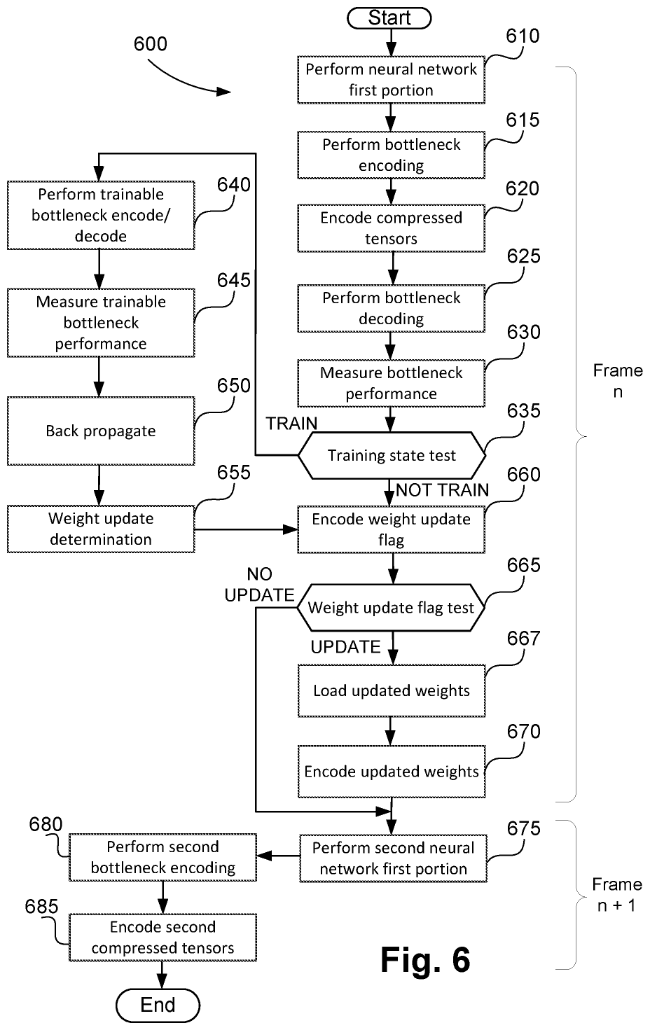

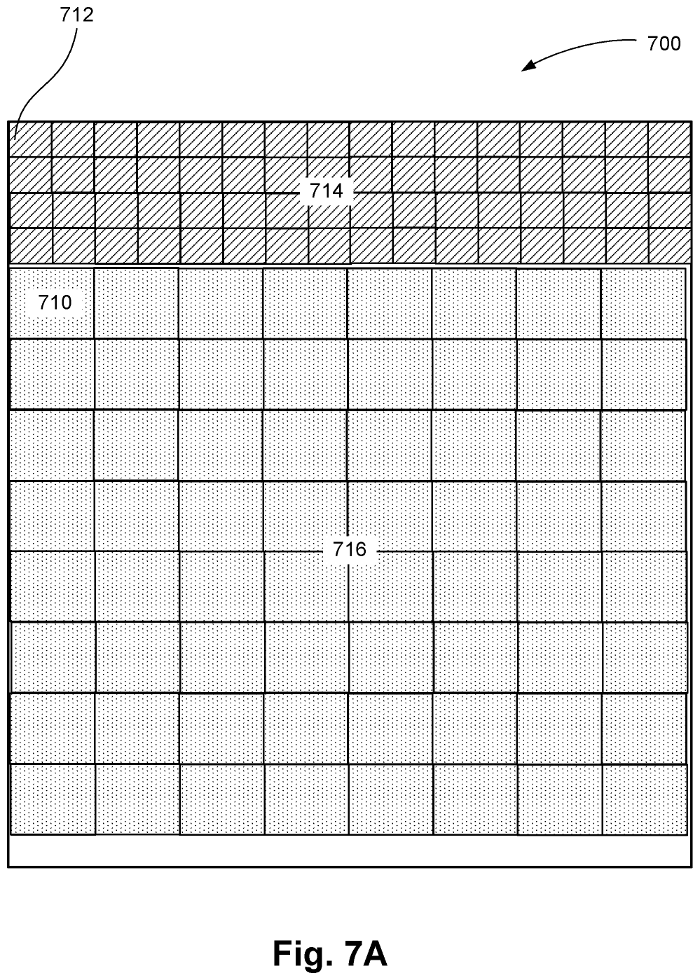

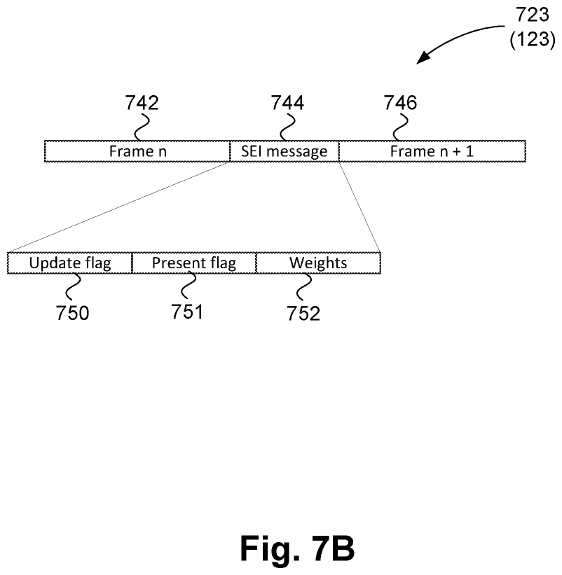

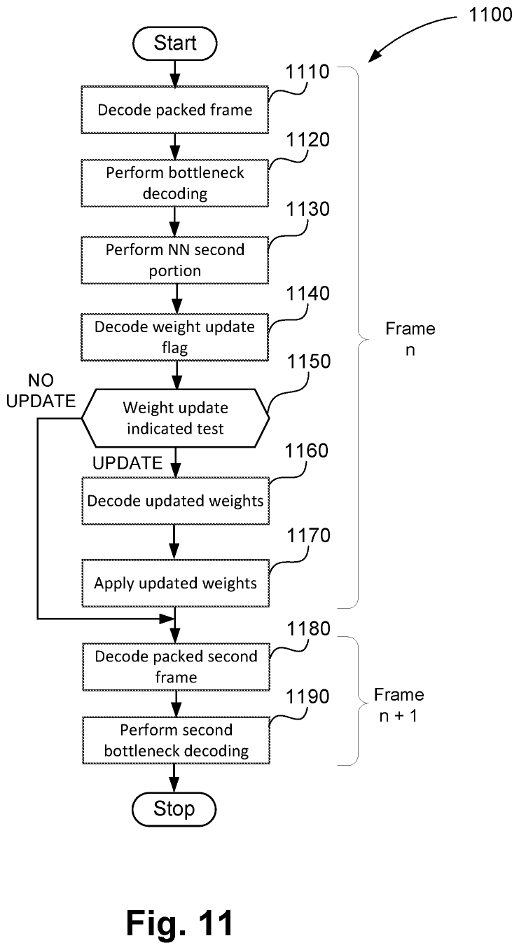

FIG. 1 is described with reference to FIG. 6, showing a method 600 for performing a first portion of a CNN and FIG. 11, showing a method 1100 for performing the second portion of the CNN. Reference is also made to FIG. 7A, showing a packing arrangement of feature maps from compressed tensors into a monochrome video frame and FIG. 7B, showing a bitstream format used in encoding and decoding the tensors.

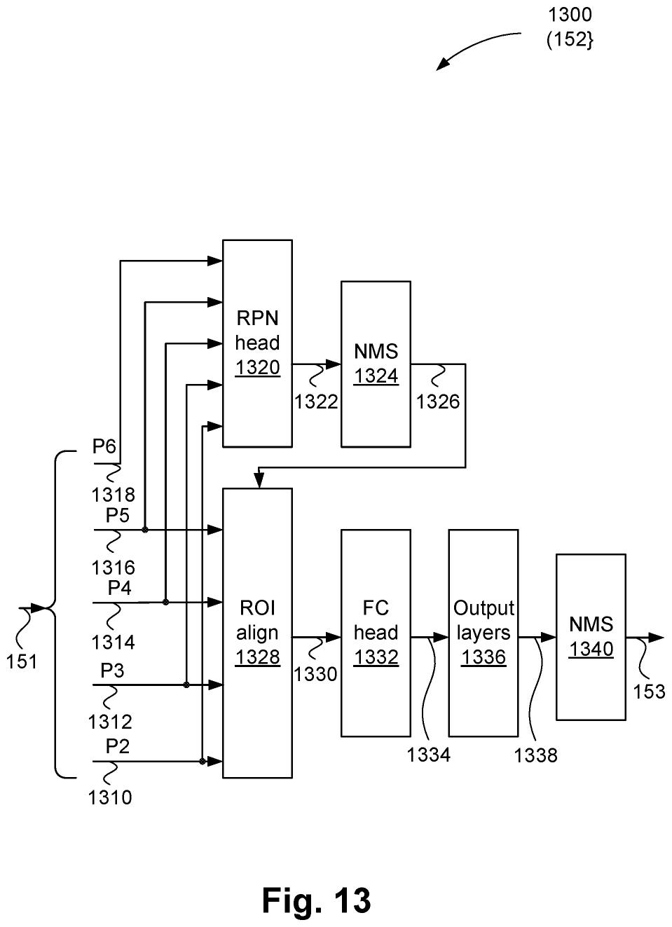

The system 100 implements a “FasterRCNN” network, used for object detection and split at an intermediate point typically described as the “P layers” into a backbone portion and a head portion in the examples described. Other networks such as “MaskRCNN” could be implemented in the system 100. Notably the backbone for FasterRCNN and MaskRCNN have the same topology and dimensionality of convolutions, batch normalisations, activation functions and the like. The head for FasterRCNN is a subset of the head for MaskRCNN, with MaskRCNN including ‘mask heads’, used for generating instance segmentation maps in addition to the bounding box output present in both FasterRCNN and MaskRCN. The mask head includes two convolutional layers and produces a segmentation map for each ‘region of interest’ resulting from the RoIAlign stage, to be described with reference to FIG. 13. As such, MaskRCNN may be used to perform both object detection and instance segmentation, with additional complexity in the network head due to use of mask heads.

The system 100 includes a source device 110 for generating encoded tensor data from a video source 112 in the form of encoded video bitstream 123. The system 100 also includes a destination device 140 for decoding tensor data in the form of the encoded video bitstream 123 to produce a task result 153. A communication channel 130 is used to communicate the encoded video bitstream 123 from the source device 110 to the destination device 140. In some arrangements, the source device 110 and destination device 140 may either or both comprise respective mobile telephone handsets (for example, “smartphones”) or network cameras and cloud applications. The communication channel 130 may be a wired connection, such as Ethernet, or a wireless connection, such as WiFi or 5G, including connections across a Wide Area Network (WAN) or across ad-hoc connections. Moreover, the source device 110 and the destination device 140 may comprise applications where encoded video data is captured on some computer-readable storage medium, such as a hard disk drive in a file server or memory.

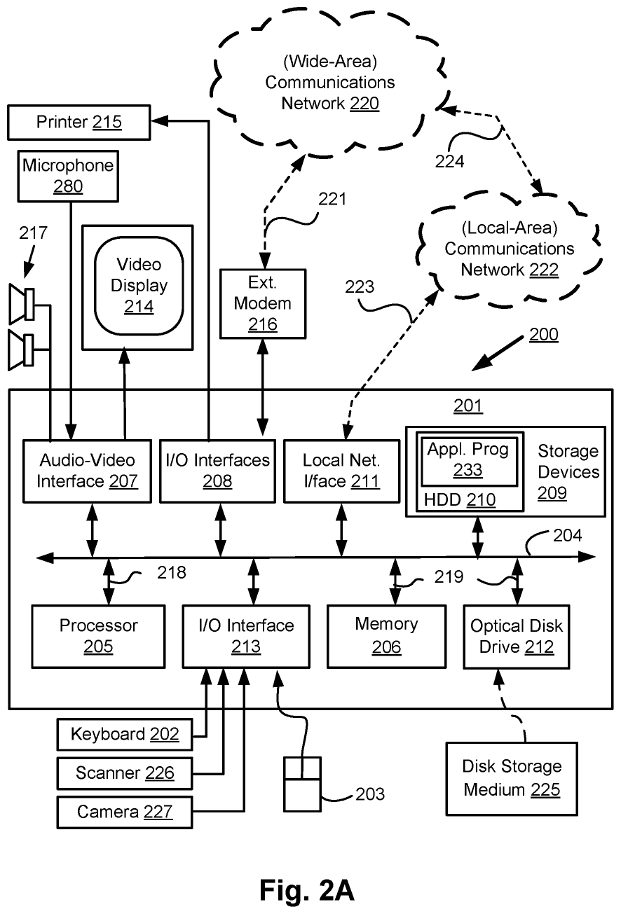

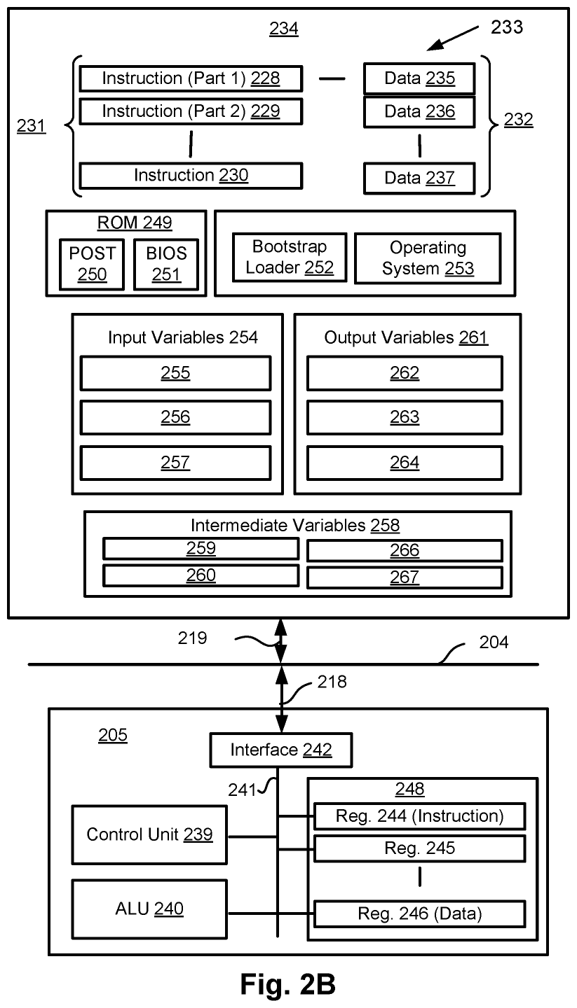

The source device 140 operates in accordance with the method 600, stored in a memory 206 and performed under execution of a processor 205 (see FIG. 2A). The method 600 may be implemented using apparatus such as a configured FPGA, an ASIC, or an ASSP. Alternatively, as described below, the method 600 may be implemented by the source device 110, as one or more software code modules of application programs 233 (see FIG. 2A), under execution of the processor 205. The software code modules of the application programs 233 implementing the method 600 may be resident, for example, in a hard disk drive 210 and/or the memory 206, to be described in relation to FIG. 2A. The method 600 encodes tensors for one frame of video data and includes functionality to update weights used for encoding tensors. The updated weights are used for encoding a subsequent frame of video data, based on the performance of currently used weights compared with an internal model having weights being updated as image frames are received by the source device 110.

The video source 112 provides a source of captured video frame data (shown as 113), such as an image capture sensor, a previously captured video sequence stored on a non-transitory recording medium, or a video feed from a remote image capture sensor. The video source 112 may also be an output of a computer graphics card, for example, displaying the video output of an operating system and various applications executing upon a computing device (for example, a tablet computer). Examples of source devices 110 that may include an image capture sensor as the video source 112 include smart-phones, video camcorders, professional video cameras, and network video cameras.

The source device 140 commences a machine task by performing a first portion of the CNN, referred to as backbone network 114, to produce intermediate tensors. The intermediate tensors are shown as 115. To facilitate bitrate reduction of the bitstream 123, the source device 140 reduces dimensionality of the tensors 115 using a compression network known as a ‘bottleneck encoder’, shown as encoder 116. The encoder 116 operates to reduce the dimensionality of the tensors 115. In the destination device 140, a ‘bottleneck decoder’, shown as 150. Restores tensor dimensionality such that output tensors 151 correspond to tensor dimensionality of the tensors 115. As the bottleneck encoder 116 and bottleneck decoder 150 include trainable network layers, a need to specify weights exists.

For the task network (comprising the backbone network 114 and a head network 152) offline training (or ‘pre-training’) is one possible mechanism to specify weights. One shortcoming of using offline-trained weights is the need for the training process to anticipate the very wide scope for varied input data. Typical video compression standards accommodate widely varying input by providing a degree of data-adaptivity, such as by the use of ‘context adaptive binary arithmetic coding’ (CABAC) to model varying input data statistics. Neural networks typically use a predetermined (fixed) weights and so are not adaptive to input data. The tensors 115 may form a multi-scale representation produced by a feature pyramid network (FPN) in the backbone 114, which is ‘fused’ together into a single tensor using an approach named ‘multi-scale feature compression’ (MSFC), for example at the encoder 116. MSFC is ordinarily used to merge all FPN layers into a single tensor and reduce spatial dimensionality of the single tensor to that of the smallest spatial resolution tensor among the FPN layer tensors. Merging all FPN layers into a single tensor is implemented at the expense of spatial detail for the less decomposed (larger) layers of the FPN.

Operation of the source device 110 is described with reference to the method 600 of FIG. 6. The method 600 commences with a perform neural network first portion step 610.

At the step 610 the CNN backbone 114 receives one frame of the video frame data 113 from the video source 112 and performs specific early layers of an overall CNN, such as layers corresponding to the ‘backbone’ of the CNN. The step 610 outputs the tensors 115. The backbone layers of the CNN 114 may produce multiple tensors as output for each frame, for example, corresponding to different spatial scales of applying a backbone including an FPN to an input image. The tensors 115 resulting from a backbone 114 with a FPN form a hierarchical representation of the frame data 113 including data of feature maps. Each successive layer of the hierarchical representation has half the width and half the height of the preceding layer. An FPN may result in three tensors in the tensors 115, corresponding to three layers output from the backbone 114, when a ‘YOLOv3’ network is performed by the system 100, the tensors 115 having varying spatial resolution and channel count. When the system 100 is performing networks such as ‘Faster RCNN X101-FPN” or “Mask RCNN X101-FPN” the tensors 115 include tensors for four layers P2-P5. Although the layers of the first portion performed in the backbone module 114 may be referred to as the ‘backbone’ of the overall task network, the specific division of layers between the source device 110 and the destination device 140 does not need to correspond to the boundary result from layers typically defined in the task network as ‘backbone’. The terms ‘backbone’ and ‘head’ are used herein to refer to any division of the network into a first and second portion, such divisions selectable based on considerations other than machine task network architecture, such as available computational resources in the source device 110 or the destination device 140.

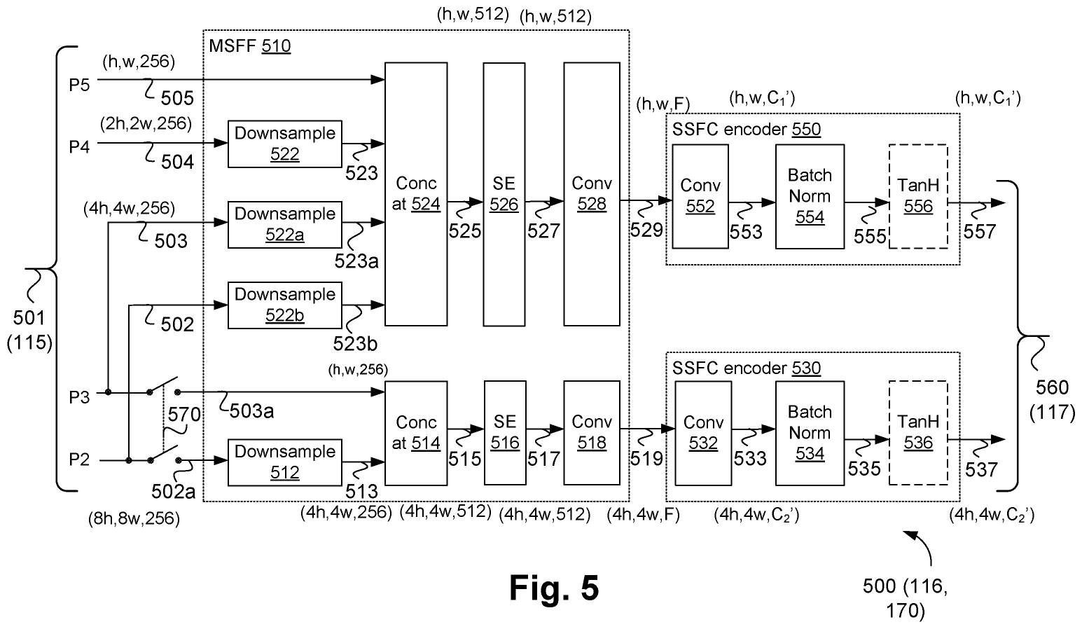

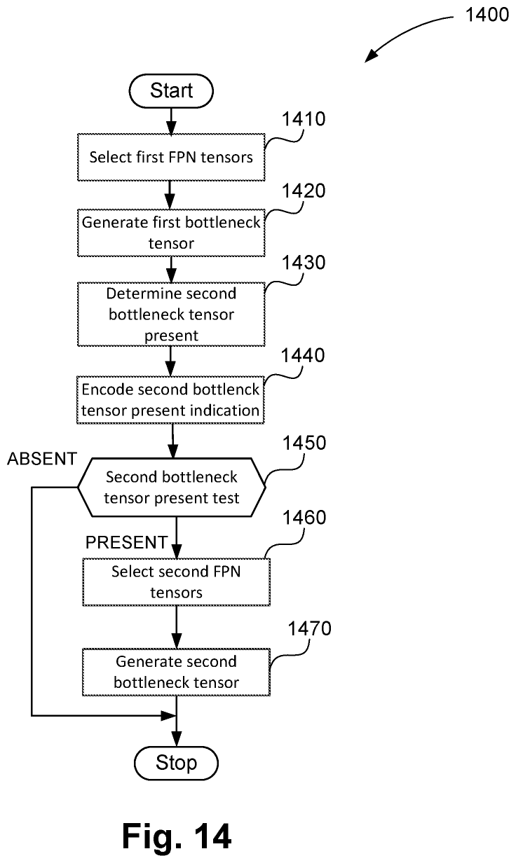

The method 600 continues under control of the processor 205 from step 610 to a perform bottleneck encoding step 615. At the step 615, the source device 110 reduces the number and dimensionality of the tensors 115 using bottleneck encoder 116 by performing a number of network layers corresponding to a compression operation that use a set of weights also associated with in the destination device 140 The step 615 receives as input at least one tensor where the neural network for a machine task has been partially performed (that is the backbone network has been implemented) and produces tensors 117. For a given frame of the frame data 113 the tensors 115 include multiple tensors by virtue of the use of an FPN in the backbone 114, having differing spatial resolutions between FPN layers. This ‘multi-scale’ representation is converted into fewer tensors in the bottleneck encoder 116, for example into one (‘base layer’) or two (‘base layer’ and ‘enhancement layer’) tensors within the reduced tensors 117 for each frame of the frame data 113, also having reduced spatial dimensions. The cross-layer fusion and spatial reduction implemented at the encoder 116 is an example of one method of deep feature compression for fusing features of a neural network. In the examples described the cross-layer fusion is implemented using techniques referred to as ‘multi-scale feature compression’ (MSFC). Operation of MFSC is described hereafter with reference to FIG. 5. Variations of MSFC as described with reference to FIG. 5 are possible, including application of the single-scale feature fusion (SSFC) for each FPN layer, with no cross-layer fusion. Application of a separate SSFC stage for each FPN layer enables channel count reduction for each layer but does not provide any means for spatial reduction for layers having larger resolution among the resolutions of the FPN layers, nor is any cross-layer redundancy exploited. Step 615 operates to perform data compression for data related to the image frame (in the example described processed by the backbone module 114). The data compression is performed by the neural network of the encoder using the currently associated or applied set of weights. The method of cross-layer fusion and spatial reduction implemented at step 615 is described with reference to a method 1400 of FIG. 14. Control in the processor 205 progresses from the step 615 to an encode compressed tensors step 620.

At the step 620 a quantise and pack module 184 quantises the tensors 117 from the floating-point domain into integer samples, such as 10-bit samples. The module 184 also packs the feature maps of each channel of the tensors 117 into a frame, using a packing format described with reference to FIG. 7A to produce a packed frame 185. A video encoder 120 encodes the packed frame 185 into a bitstream 123 as compressed tensors 121. Control in the processor 205 progresses from the step 620 to a perform bottleneck decoding step 625.

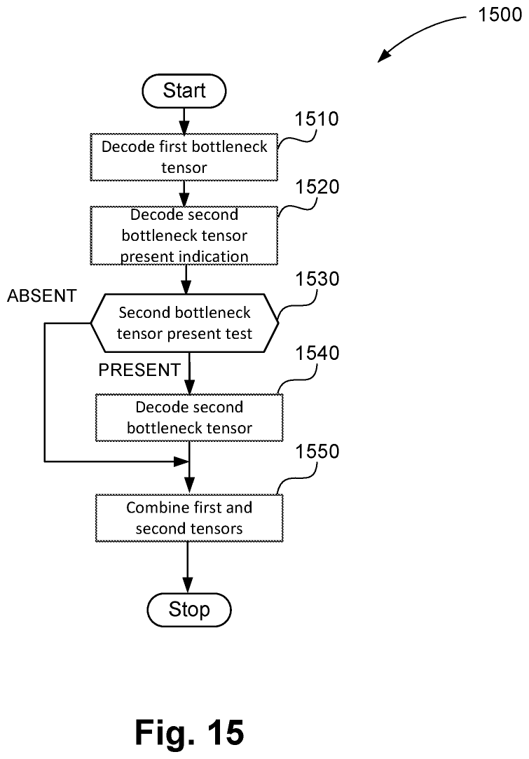

At the step 625 the tensors 117 are supplied to a bottleneck decoder 118. The bottleneck decoder 118 operates with a set of weights known to the destination device 140 to produce restored tensors 119 from the tensors 117. The restored tensors 119 have the same dimensionality of tensors as the tensors 115. The tensors 119 represent a degraded version of the tensors 115, with loss due to the constricted dimensionality of the tensors 117 and a degree of optimality of the weights of the modules 116 and 118 for the incoming tensor statistics. The bottleneck decoder 118 is initialised with the same weights as used in a bottleneck decoder 150. A method 1500, described with reference to FIG. 15, shows one approach for producing restored tensors 119 from the tensors 117. Control in the processor 205 progresses from the step 625 to a measure bottleneck performance step 630.

At the step 630, a value for evaluating data compression using the weights determined at step 640 is determined or acquired. For example, a mean square error (MSE) module 178 compares the tensors 115 with the tensors 119, producing an MSE value 179 indicating loss due to the conversion to and from the reduced dimensionality of the tensors 117. Over time statistics of the tensors 115 can change, leading to a reduction of performance of the bottleneck encoder 116 and the bottleneck decoder 118, seen as a reduction in the MSE 179, although short-term variation in MSE can also be expected. The MSE 179 provides an indication of the expected signal quality of the tensors 151 in the destination device 140, with the exception that the lossy video encoding process of the video encoder 120 is not included in this indication. Accordingly, the MSE 179 gives an indication of the performance of the bottleneck encoder and decoder (i.e., 116, 118, 150) in preserving tensor data passing from the backbone 114 to the head 152. The value 179 is obtained or acquired using the tensor 115 input to the encoder 116 and the tensor 119 after data compression using the weights associated with the neural network at steps 615 and 630. In other implementations, mechanisms other than MSE can be used for evaluating data compression. Control in the processor 205 progresses from the step 630 to a training state step 635.

At the step 635 the processor 205 updates a training state variable based on the MSE value 179. The training state variable is stored in the memory 206 and indicates whether the source device 110 is currently performing training on a set of modules or not. If the MSE value 179 falls below a threshold, the training state variable is set to a ‘TRAINING’ state. The threshold may be determined in a number of ways, for example using a moving average of previously generated MSE values 179, based on a desired MSE value compared to a moving average of MSE values, compared to a predetermined or configurable threshold, or the like. If, after a period of training no weight update has been made the training state variable may be set back to cease further training. If the training state variable indicates training is underway, control in the processor 205 progresses from the step 635 to a perform trainable bottleneck encode/decode step 640 (‘TRAIN’ in FIG. 6). Independently of measures such as the MSE value 179 the step 635 may operate to enter the TRAINING state periodically, for example, once per day or once per week, providing an on-going means to determine if an improved model can be generated even in the absence of a clear indication of degraded performance, such as a drop in measured MSE value 179. If the training state variable does not indicate training is underway, control in the processor 205 progresses from the step 635 to an encode weight update flag step 660 (‘NOT TRAIN’ in FIG. 6).

At the step 640 a trainable bottleneck encoder 170 and a trainable bottleneck decoder 174 operate to compress and decompress the tensors 115 to produce tensors 175. The trainable bottleneck encoder 170 has the same structure as the encoder 116. The trainable bottleneck decoder 174 has the same structure as the decoder 150. Structural compatibility between the modules 170 with 116, and between the modules 174 with 150 enables weights generated in the modules 170 and 174 to be transferred to the modules 116 and 150, respectively, to be used for subsequent processing. Compressed tensors 171 are output from the trainable bottleneck encoder 170 and passed to the trainable bottleneck decoder 174. A forward pass through the modules 170 and 174 is performed using weights currently present in the modules 170 and 174. The network topology and layer dimensionality of the modules 170 and 174 correspond to those of the modules 116 and 118, respectively. Operation of the modules 170 and 174 accords with methods 1400 and 1500, described with reference to FIGS. 14 and 15, respectively. Control in the processor 205 progresses from the step 640 to a measure trainable bottleneck performance step 645.

At the step 645, a value for evaluating data compression using the weights determined at step 640 is determined or acquired. The step 645 uses the same mechanism as the step 630 to evaluate data compression performance. For example, a mean-square error (MSE) module 180 produces a measured loss 181 by performing a mean-square error computation on the tensors 115 and 175. The measured loss 181 value provides a measure of the ability of the modules 170 and 174 to accurately restore tensors after being constricted in dimensionality by virtue of using the reduced dimensionality tensor 171. Control in the processor 205 progresses from the step 645 to a back propagate step 650.

At the step 650 a weight update is performed in the modules 170 and 174 using a process of ‘back propagation’ whereby weights are updated based on a process, such as stochastic gradient descent (SGD), attempting to minimise the measured loss 181. The trainable bottleneck encoder 170 and the trainable bottleneck decoder 174, by virtue of ongoing weight updating due to back propagation, are able to adapt to such changes in statistics of the tensors 115, resulting in the potential for achievement of a lower MSE 181 compared to the MSE 179. The rate at which weights are updated is scaled by a ‘learning rate’. A higher learning rate generally results in the measured loss being minimised with fewer back-propagation operations, i.e., a faster training process, but risks instability in the training due to over-adjusting weights that prevents the finding of a local minima of the loss function. A smaller learning rate can take a longer time to train the network however smaller learning rate values are also less likely to over-adjust the rates. When using a small batch size such as one image, a smaller learning rate is desirable to reduce the impact of individual frames that may be outliers statistically. Typical learning rates may be values such as 0.01 or 0.001 and may be scaled by the reciprocal of the batch size, or by the reciprocal of the square root of the batch size to arrive at a final learning rate for a given batch. Learning rates may be varied over time, with larger values used initially when network weights are far from the weights' final values and smaller values used later, when the network is close to an optimal or acceptable state in terms of MSE. In the context of refinement training of the bottleneck encoder and decoder, smaller learning rates such as between 0.001 to 0.0001 are suitable. Although the modules 170 and 174 receive tensors one at a time, incoming tensors may be grouped into batches of a size greater than one. Increasing the batch size can improve training as each weight update step is influenced by a variety of inputs. Increasing the batch size increases the memory requirement for the modules 170 and 174. Moreover, for video data the statistical variety in consecutive frames or consecutive tensors from the backbone 114 is less pronounced, reducing the benefit of using a larger batch size. Other processes to update weights may also be used, such as the ‘AdamW’ optimiser which utilises momentum and scaling and decouples weight decay from gradient update. The reduced tensors 171 form the result of a bottleneck encoder and decoder (i.e., 170 and 174) undergoing training or adaptation to actual input data as it is encountered, i.e., the frame data 113, converted to the tensors 115. Control in the processor 205 progresses from the step 650 to a weight update determination step 655.

At the step 655 a trigger module 182 compares the MSE 179 with the MSE 181. If the MSE 179 is observed to be below the MSE 181 for a period of time and with a difference exceeding a threshold, a weight update process is initiated. The period of time may correspond to a number of frames, a moving average, or a combination thereof, indicative of sub-par performance of the modules 116 and 118 compared to achievable performance as indicated by the modules 170 and 174. Heuristics for initiating a weight update are adapted to capture the point at which currently in-use weights for tensor reduction and restoration (i.e., conversion of the tensors 115 to the tensors 117 and finally to the tensors 119 or 151) are no longer well suited to the statistics of the received input data. Weights used in the modules 170 and 174 are costly to encode in the bitstream 123 and so are not sent to the destination device 140 on each update operation. A less frequent transmission of updated weights, resulting from the determination of the step 655, from the source device 110 to the destination device 140, for example based on detection of performance degradation while using currently active weights, is sufficient for adequate system performance. The result of the step 655 is a decision to perform a weight update or not in the form of a weight update flag 750. The steps 625 to 655 operate to determine whether a set of weights for data compression applied in a next round of data compression is to be changed. Whether a change is to be implemented is determined based on a comparison of the MSE values 181 and 179. If a weight update or change is to be performed the training state variable is also reset to cease further training on subsequent invocations of the method 600. Control in the processor 205 progresses from the step 655 to the encode weight update flag step 660.

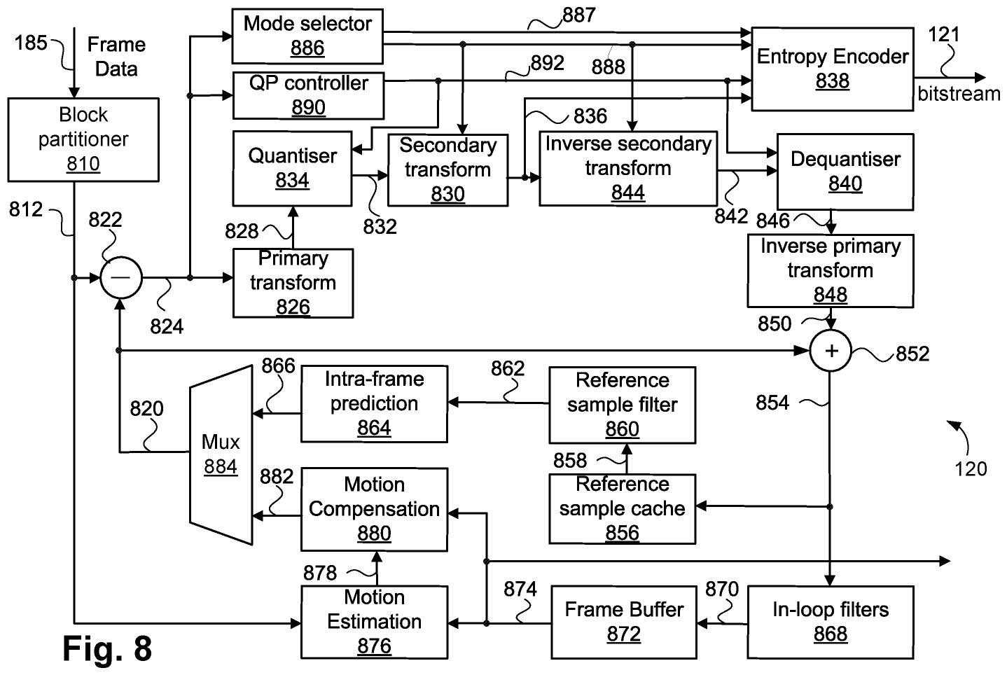

At the step 660 an entropy encoder 838, to be described with reference to FIG. 8, encodes the weight update flag into the bitstream 123 as a weight update flag 750. The indication to update weights may be included in a supplementary enhancement information (SEI) message associated with the current packed frame 185. An SEI message 744 contains weights and may be associated with the current packed frame 185, either including the weight update flag 750, or with a separate SEI message containing the weight update flag 750. Alternatively, the presence of an SEI message containing weights may be the indication from the source device 140 to the destination device 140 that a weight update is to be performed. Control in the processor 205 progresses from the step 660 to a weight update flag test step 665.

At the step 665 control in the processor 205 progresses to a load updated weights step 667 if the weight update flag 750 indicates the determination in the trigger module 182 is that the weights are to be changed or updated (“UPDATE” as shown in FIG. 6). Otherwise, if the weight update flag does not indicate a determination in the trigger module 182 to perform an update of the weights, control in the processor 205 progresses from the step 665 to a being processing the next frame of video data at a perform neural network first portion step 675 (“NO UPDATE” as shown in FIG. 6).

At the step 667 the bottleneck decoder weights 176 are passed from the bottleneck decoder 174 to the bottleneck decoder 118 and to a weight encoder 186. The bottleneck encoder weights 172 from the trainable bottleneck encoder 170 are loaded into or applied to the bottleneck encoder 116. The change in weights may point to a particular stored set of values or replace previously stored values. At step 667 the association of the encoder 116 is changed to the weights 172 from the set of weights used at step 615. Associating the weights 172 with the encoder 116 may involve loading the weights 172 into a region of the memory 206 referenced by the encoder 116 or altering a pointer to select the weights 172 for subsequent use in the encoder 116. Control in the processor 205 progresses from the step 667 to an encode updated weights step 670.

At the step 670, a weight encoder 186 encodes the bottleneck decoder weights 176 to produce encoded weights 187. The encoded weights 187 are stored in the bitstream 123 (as weights 752 of FIG. 7B) using a multiplexor 122. Encoding the weights 187 may involve encode the weights 187 directly, using variable-length codewords to compress each weight value. Arithmetic coding schemes such as context adaptive binary arithmetic coding (CABAC) may be employed for encoding the weights 187. Alternatively, the encoded information can represent a delta between weights, for example a delta relative to weights previously used by the bottleneck decoder 118 and also known by the bottleneck decoder 146, by virtue of previous weight updates and a synchronised initial state. One example syntax available for representing the weights is the standard ISO/IEC 15938-17, sometimes referred to as “Neural Network Coding” or “Neural Network Representation” or “MPEG-NNR”, although other means for efficiently encoding neural network weights into a bitstream may be used, such as “Open Neural Network Exchange Intermediate Representation”. Upon completion of the step 670, encoding the partial task result, i.e., the tensors 115, is completed for one frame from the video source 112. A progression to a subsequent frame, such as the next frame, occurs. Remaining steps in the method 600 relate to a subsequent frame from the video source 112, showing the use or not of updated weights as determined at the step 655. Control in the processor 205 progresses from the step 670 to a perform second neural network first portion step 675.

At the step 675, similar to the step 610, the neural network first portion is performed on a subsequent frame of the frame data, for example frame 113a, from the video source 112, producing updated tensors for the frame 113a, such as tensors 115a. Control in the processor 205 progresses from the step 675 to a perform second bottleneck encoding step 680.

At the step 680, similar to the step 615, the bottleneck encoder 116 performs an encoding of the updated tensors 115a to produce updated tensors 117a. The step 680 performs encoding using bottleneck encoder weights 172 received from the trainable bottleneck encoder 172 by the bottleneck encoder 116 if a weight update is performed at the step 667, as determined at the step 655. In other words, data compression is performed using the associated updated set of weights 176. Control in the processor 205 progresses from the step 680 to an encode second compressed tensors step 685.

At the step 685, similarly to the step 620, the updated tensors 117a, represented as a packed frame in accordance with the format of the frame 700, are encoded into a video bitstream 121 as compressed frame N+1 (see 746 of FIG. 7B) by the video encoder 120. The video bitstream 121 is multiplexed into the bitstream 123 by the multiplexor 122. The source device 140, under execution of the processor 205, continues to encode feature maps for successive frames of the video data 113 from the backbone 114, with trainable layers such as those of the modules 116 and 118 updated from time to time as determined by the module 182. As a result of operation of the method 600, the bitstream 123 contains encoded tensors from a first portion of a neural network, and in some instances a dynamic update of weights for reducing tensor dimensionality. The update is contingent on performance of the bottleneck encoder 116 relative to achievable performance with the bottleneck encoder and decoder 170 and 174. Training on received data in the modules 170 and 174 exploits the property that for compression tasks, the objective is to restore input data with minimal loss. In other words, for compression tasks, the ground truth is the input data. Training performed by the modules 170 and 174 happens concurrently with use of the ‘deployed’ network weights present in the modules 116, 118, and 150, and uses the same input data. Accordingly, training performed by the modules 170 and 174 can be said to be ‘overfitting’ to the current input data. However since the network is capable of dynamic weight updating this overfitting behaviour can be considered as data-driven adaptation. Support for refinement training alleviates the need to increase complexity of training of the bottleneck encoder and decoder, and/or complexity of the bottleneck encoder and decoders themselves, to accommodate a wider statistical variety of input data. Considering the data path provided in the system 100 from input frame 113 to task result 153, i.e., modules 114, 116, 150, and 152, the trainable portion of this path corresponds to modules 116 and 150, forming a subset of the total CNN layers in the data path.

Operation of the destination device 140 portion of the system 100 is described with reference to the method 1100 of FIG. 11. The method 1100 relates to data encoded at the source device in which neural network processing for a machine task has been partially performed (i.e. by the backbone network 114). The method 1100 can be implemented by software code modules of the application programs 233 stored on the memory 206 and controlled by execution of the processor 205. The method 1100 commences at a decode packed frame step 1110.

At the step 1110 a demultiplexer 142 received the bitstream 123. The demultiplexer 142 extracts a video bitstream 143, corresponding to the bitstream 121, from the bitstream 123. The video bitstream 143 is supplied to a video decoder 146 to produce a decoded packed frame 162. The decoded packed frame 162 is passed to an unpack and dequantize module 160. The module 160 extracts and inverse quantises each feature map from the packed frame 162 from the integer sample domain to the floating point domain, arranging the feature maps into tensors, such as the decoded tensors 147. Control in the processor 205 progresses from the step 1110 to a perform bottleneck decoding step 1120.

At the step 1120 the bottleneck decoder 150, containing weights for layers such as convolutional layers, converts the tensors 147 to the tensors 151, having increased dimensionality compared to the tensors 147. The bottleneck decoder 150 operates to decode data related to an image (including the case of image frames of a video) where compression was already performed at the source device 110. The decoding is performed by the neural network of the bottleneck decoder 150 using a current associated set of weights. The bottleneck decoder 150 uses a decoding method associated with the encoding or compression implemented by the bottleneck encoder 116, for example MFSC. Operation of the bottleneck decoder 150 accords with the method 1500 described with reference to FIG. 15. Control in the processor 205 progresses from the step 1120 to a perform neural-network second portion step 1130.

At the step 1130 the head module 152 performs the second portion of the overall neural network implemented in the system 100 to produce the task result 153. The task result 153 is stored in a task result buffer 154, generally implemented in the memory 206. The method 1100 accordingly implements the remaining portion of the neural network machine task at step 1130. Control in the processor 205 progresses from the step 1130 to a decode weight update flag step 1140.

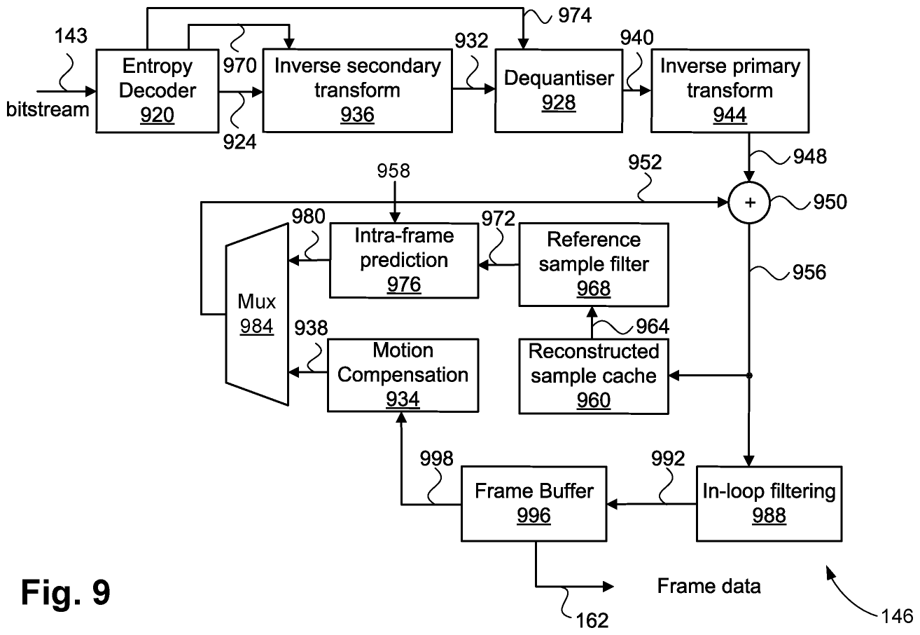

At the step 1140 an entropy decoder 920, to be described with reference to FIG. 9, decodes the weight update flag 750 from the bitstream 123. The weight update flag 750 provides information indicating whether a set of weights for bottleneck decoding is to be changed, that is whether weights in the bottleneck decoder 150 are to be updated or not, as determined by the trigger module 182. Control in the processor 205 progresses from the step 1140 to a weight update indicated test step 1150.

At the step 1150 the application 233 determines if, based on the decoded weight update flag, weights are to be updated. Control in the processor 205 progresses to a decode updated weights step 1160 if an update or change in weights is indicated by the weight update flag 750 (“UPDATE” at step 1150). As described in relation to step 670, the information can relate to the weight values or a delta between weight values. Otherwise control in the processor 205 progresses to a decode packed second frame step 1180 (“NO UPDATE”at step 1150).

At the step 1160 information indicating the encoded weights 145 is extracted from the bitstream 123 using the demultiplexer 142. A weight decoder 148 converts or decodes the encoded weights 145 to decoded weights 149. Control in the processor 205 progresses from the step 1160 to an apply updated weights step 1170.

At the step 1170 the bottleneck decoder 150 is updated to use or apply the decoded weights 149, maintaining synchronisation of weights with those present in the bottleneck decoder 118 in the source device 140. In other words, the association of the neural network of the bottleneck decoder 150 is updated to use the weights 149 from the weights used in step 1120. The update may point to a particular stored set of values or replace previously stored values. Upon completion of the step 1170, the CNN task implemented in the backbone 114 and the head 152 has been performed for one frame and a progression to a subsequent frame, such as the next frame, occurs. Control in the processor 205 progresses from the step 1170 to the step 1180.

At the step 1180, similarly to the step 1110, the video decoder 146 decodes second encoded frame 746 from the bitstream 123 to produce a second packed frame, for example frame 147a. Control in the processor 205 progresses from the step 1180 to a perform second bottleneck decoding step 1190.

At the step 1190 the bottleneck decoder 150, using the weights 149 if indicated by the weight update flag 750, decodes the frame 147a to produce second decoded tensors 151a. The destination device 140 continues with running the CNN head 152 using the tensors 151a to produce another task result, such as result 153a, and continues decoding subsequent frames with weights used in the bottleneck decoder updated from time to time as indicated by the decoded weight update flag 750.

The contents of the task result buffer 154 may be presented to the user, for example via a graphical user interface, or provided to an analytics application where some action is decided based on the task result, which may include summary level presentation of aggregated task results to a user. The functionality of each of the source device 110 and the destination device 140 may in some implementations be embodied in a single device, examples of which include mobile telephone handsets and tablet computers and cloud applications.

Notwithstanding the example devices mentioned above, each of the source device 110 and destination device 140 may be configured within a general-purpose computing system, typically through a combination of hardware and software components. FIG. 2A illustrates such a computer system 200, which includes: a computer module 201; input devices such as a keyboard 202, a mouse pointer device 203, a scanner 226, a camera 227, which may be configured as the video source 112, and a microphone 280; and output devices including a printer 215, a display device 214, which may be configured as a display device presenting the task result 151, and loudspeakers 217. An external Modulator-Demodulator (Modem) transceiver device 216 may be used by the computer module 201 for communicating to and from a communications network 220 via a connection 221. The communications network 220, which may represent the communication channel 130, may be a (WAN), such as the Internet, a cellular telecommunications network, or a private WAN. Where the connection 221 is a telephone line, the modem 216 may be a traditional “dial-up” modem. Alternatively, where the connection 221 is a high capacity (for example cable or optical) connection, the modem 216 may be a broadband modem. A wireless modem may also be used for wireless connection to the communications network 220. The transceiver device 216 may provide the functionality of the transmitter 122 and the receiver 142 and the communication channel 130 may be embodied in the connection 221.

The computer module 201 typically includes at least one processor unit 205, and the memory unit 206. For example, the memory unit 206 may have semiconductor random access memory (RAM) and semiconductor read only memory (ROM). The computer module 201 also includes a number of input/output (I/O) interfaces including: an audio-video interface 207 that couples to the video display 214, loudspeakers 217 and microphone 280; an I/O interface 213 that couples to the keyboard 202, mouse 203, scanner 226, camera 227 and optionally a joystick or other human interface device (not illustrated); and an interface 208 for the external modem 216 and printer 215. The signal from the audio-video interface 207 to the computer monitor 214 is generally the output of a computer graphics card. In some implementations, the modem 216 may be incorporated within the computer module 201, for example within the interface 208. The computer module 201 also has a local network interface 211, which permits coupling of the computer system 200 via a connection 223 to a local-area communications network 222, known as a Local Area Network (LAN). As illustrated in FIG. 2A, the local communications network 222 may also couple to the wide network 220 via a connection 224, which would typically include a so-called “firewall”device or device of similar functionality. The local network interface 211 may comprise an Ethernet™M circuit card, a Bluetooth™ wireless arrangement or an IEEE 802.11 wireless arrangement; however, numerous other types of interfaces may be practiced for the interface 211. The local network interface 211 may also provide the functionality of the transmitter 122 and the receiver 142 and communication channel 130 may also be embodied in the local communications network 222.

The I/O interfaces 208 and 213 may afford either or both of serial and parallel connectivity, the former typically being implemented according to the Universal Serial Bus (USB) standards and having corresponding USB connectors (not illustrated). Storage devices 209 are provided and typically include the hard disk drive (HDD) 210. Other storage devices such as a floppy disk drive and a magnetic tape drive (not illustrated) may also be used. An optical disk drive 212 is typically provided to act as a non-volatile source of data. Portable memory devices, such optical disks (for example, CD-ROM, DVD, Blu ray Disc™), USB-RAM, portable, external hard drives, and floppy disks, for example, may be used as appropriate sources of data to the computer system 200. Typically, any of the HDD 210, optical drive 212, networks 220 and 222 may also be configured to operate as the video source 112, or as a destination for decoded video data to be stored for reproduction via the display 214. The source device 110 and the destination device 140 of the system 100 may be embodied in the computer system 200.

The components 205 to 213 of the computer module 201 typically communicate via an interconnected bus 204 and in a manner that results in a conventional mode of operation of the computer system 200 known to those in the relevant art. For example, the processor 205 is coupled to the system bus 204 using a connection 218. Likewise, the memory 206 and optical disk drive 212 are coupled to the system bus 204 by connections 219. Examples of computers on which the described arrangements can be practised include IBM-PC's and compatibles, Sun SPARCstations, Apple Mac™ or alike computer systems.

Where appropriate or desired, the source device 110 and the destination device 140, as well as methods described below, may be implemented using the computer system 200. In particular, the source device 110, the destination device 140 and methods to be described, may be implemented as one or more software application programs 233 executable within the computer system 200. The source device 110, the destination device 140 and the steps of the described methods are effected by instructions 231 (see FIG. 2B) in the software 233 that are carried out within the computer system 200. The software instructions 231 may be formed as one or more code modules, each for performing one or more particular tasks. The software may also be divided into two separate parts, in which a first part and the corresponding code modules performs the described methods and a second part and the corresponding code modules manage a user interface between the first part and the user.

The software may be stored in a computer readable medium, including the storage devices described below, for example. The software is loaded into the computer system 200 from the computer readable medium, and then executed by the computer system 200. A computer readable medium having such software or computer program recorded on the computer readable medium is a computer program product. The use of the computer program product in the computer system 200 preferably effects an advantageous apparatus for implementing the source device 110 and the destination device 140 and the described methods.

The software 233 is typically stored in the HDD 210 or the memory 206. The software is loaded into the computer system 200 from a computer readable medium and executed by the computer system 200. Thus, for example, the software 233 may be stored on an optically readable disk storage medium (for example, CD-ROM) 225 that is read by the optical disk drive 212.

In some instances, the application programs 233 may be supplied to the user encoded on one or more CD-ROMs 225 and read via the corresponding drive 212, or alternatively may be read by the user from the networks 220 or 222. Still further, the software can also be loaded into the computer system 200 from other computer readable media. Computer readable storage media refers to any non-transitory tangible storage medium that provides recorded instructions and/or data to the computer system 200 for execution and/or processing. Examples of such storage media include floppy disks, magnetic tape, CD-ROM, DVD, Blu-ray Disc™, a hard disk drive, a ROM or integrated circuit, USB memory, a magneto-optical disk, or a computer readable card such as a PCMCIA card and the like, whether or not such devices are internal or external of the computer module 201. Examples of transitory or non-tangible computer readable transmission media that may also participate in the provision of the software, application programs, instructions and/or video data or encoded video data to the computer module 201 include radio or infra-red transmission channels, as well as a network connection to another computer or networked device, and the Internet or Intranets including e-mail transmissions and information recorded on Websites and the like.

The second part of the application program 233 and the corresponding code modules mentioned above may be executed to implement one or more graphical user interfaces (GUIs) to be rendered or otherwise represented upon the display 214. Through manipulation of typically the keyboard 202 and the mouse 203, a user of the computer system 200 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 217 and user voice commands input via the microphone 280.

FIG. 2B is a detailed schematic block diagram of the processor 205 and a “memory” 234. The memory 234 represents a logical aggregation of all the memory modules (including the storage devices 209 and semiconductor memory 206) that can be accessed by the computer module 201 in FIG. 2A.

When the computer module 201 is initially powered up, a power-on self-test (POST) program 250 executes. The POST program 250 is typically stored in a ROM 249 of the semiconductor memory 206 of FIG. 2A. A hardware device such as the ROM 249 storing software is sometimes referred to as firmware. The POST program 250 examines hardware within the computer module 201 to ensure proper functioning and typically checks the processor 205, the memory 234 (209, 206), and a basic input-output systems software (BIOS) module 251, also typically stored in the ROM 249, for correct operation. Once the POST program 250 has run successfully, the BIOS 251 activates the hard disk drive 210 of FIG. 2A. Activation of the hard disk drive 210 causes a bootstrap loader program 252 that is resident on the hard disk drive 210 to execute via the processor 205. This loads an operating system 253 into the RAM memory 206, upon which the operating system 253 commences operation. The operating system 253 is a system level application, executable by the processor 205, to fulfil various high-level functions, including processor management, memory management, device management, storage management, software application interface, and generic user interface.

The operating system 253 manages the memory 234 (209, 206) to ensure that each process or application running on the computer module 201 has sufficient memory in which to execute without colliding with memory allocated to another process. Furthermore, the different types of memory available in the computer system 200 of FIG. 2A need to be used properly so that each process can run effectively. Accordingly, the aggregated memory 234 is not intended to illustrate how particular segments of memory are allocated (unless otherwise stated), but rather to provide a general view of the memory accessible by the computer system 200 and how such memory is used.

As shown in FIG. 2B, the processor 205 includes a number of functional modules including a control unit 239, an arithmetic logic unit (ALU) 240, and a local or internal memory 248, sometimes called a cache memory. The cache memory 248 typically includes a number of storage registers 244-246 in a register section. One or more internal busses 241 functionally interconnect these functional modules. The processor 205 typically also has one or more interfaces 242 for communicating with external devices via the system bus 204, using a connection 218. The memory 234 is coupled to the bus 204 using a connection 219.

The application program 233 includes a sequence of instructions 231 that may include conditional branch and loop instructions. The program 233 may also include data 232 which is used in execution of the program 233. The instructions 231 and the data 232 are stored in memory locations 228, 229, 230 and 235, 236, 237, respectively. Depending upon the relative size of the instructions 231 and the memory locations 228-230, a particular instruction may be stored in a single memory location as depicted by the instruction shown in the memory location 230. Alternately, an instruction may be segmented into a number of parts each of which is stored in a separate memory location, as depicted by the instruction segments shown in the memory locations 228 and 229.

In general, the processor 205 is given a set of instructions which are executed therein. The processor 205 waits for a subsequent input, to which the processor 205 reacts to by executing another set of instructions. Each input may be provided from one or more of a number of sources, including data generated by one or more of the input devices 202, 203, data received from an external source across one of the networks 220, 202, data retrieved from one of the storage devices 206, 209 or data retrieved from a storage medium 225 inserted into the corresponding reader 212, all depicted in FIG. 2A. The execution of a set of the instructions may in some cases result in output of data. Execution may also involve storing data or variables to the memory 234.

The bottleneck encoder 116, the bottleneck decoder 148 and the described methods may use input variables 254, which are stored in the memory 234 in corresponding memory locations 255, 256, 257. The bottleneck encoder 116, the bottleneck decoder 148 and the described methods produce output variables 261, which are stored in the memory 234 in corresponding memory locations 262, 263, 264. Intermediate variables 258 may be stored in memory locations 259, 260, 266 and 267.

Referring to the processor 205 of FIG. 2B, the registers 244, 245, 246, the arithmetic logic unit (ALU) 240, and the control unit 239 work together to perform sequences of micro-operations needed to perform “fetch, decode, and execute” cycles for every instruction in the instruction set making up the program 233. Each fetch, decode, and execute cycle comprises: a fetch operation, which fetches or reads an instruction 231 from a memory location 228, 229, 230;
a decode operation in which the control unit 239 determines which instruction has been fetched; and
an execute operation in which the control unit 239 and/or the ALU 240 execute the instruction.

Thereafter, a further fetch, decode, and execute cycle for the next instruction may be executed. Similarly, a store cycle may be performed by which the control unit 239 stores or writes a value to a memory location 232.

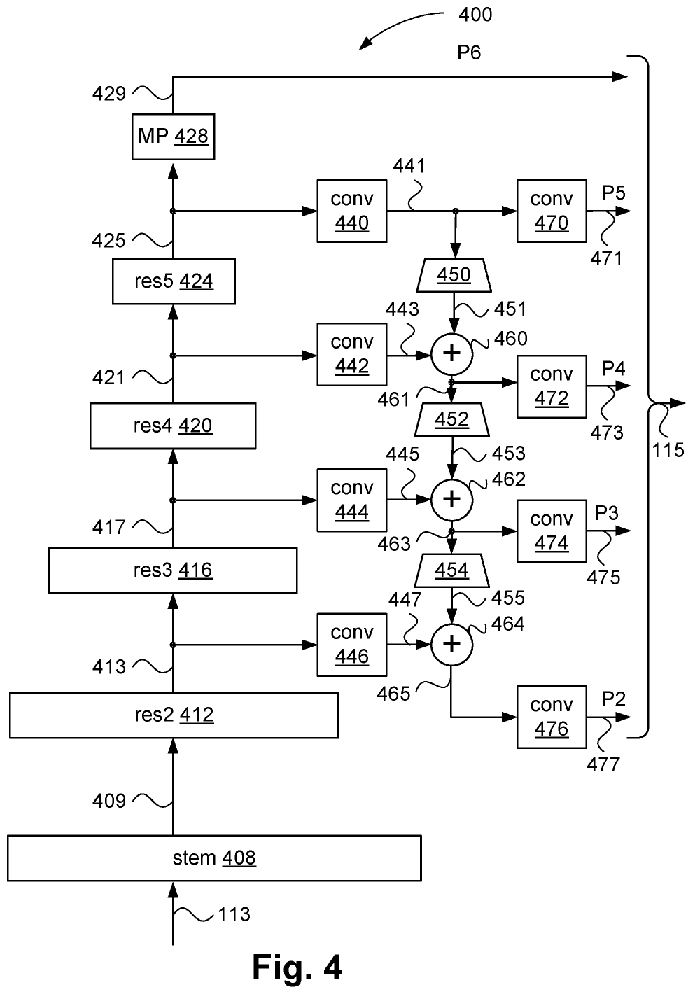

Each step or sub-process in the methods of FIGS. 4 to 15 is associated with one or more segments of the program 233 and is typically performed by the register section 244, 245, 247, the ALU 240, and the control unit 239 in the processor 205 working together to perform the fetch, decode, and execute cycles for every instruction in the instruction set for the noted segments of the program 233.

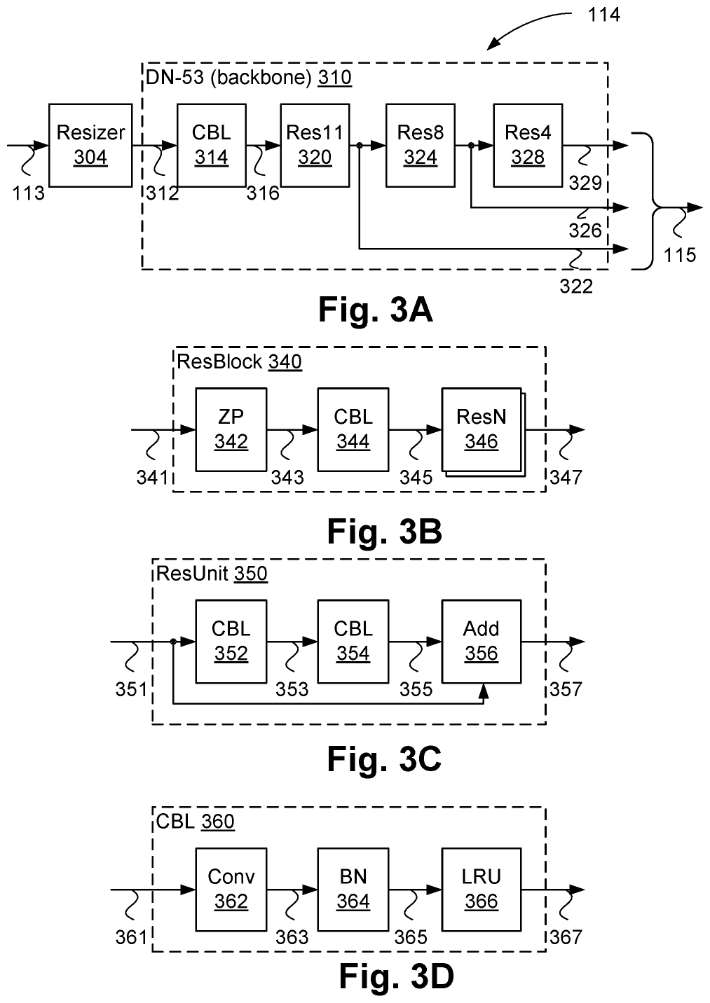

FIG. 3A is a schematic block diagram showing functional modules of a backbone portion 310 of a CNN, which may serve as the CNN backbone 114. The backbone portion 114 is sometimes referred to as ‘DarkNet-53’ and forms the backbone of a ‘YOLOv3’ object detection network. Different backbones are also possible, resulting in a different number of and dimensionality of layers of the tensors 115 for each frame.

As shown in FIG. 3A, the video data 113 is passed to a resizer module 304. The resizer module 314 resizes the frame to a resolution suitable for processing by the CNN backbone 310, producing resized frame data 312. If the resolution of the frame data 113 is already suitable for the CNN backbone 310 then operation of the resizer module 304 is not needed. The resized frame data 312 is passed to a convolutional batch normalisation leaky rectified linear (CBL) module 314 to produce tensors 316. The CBL 314 contains modules as described with reference to a CBL module 360, as shown in FIG. 3D.

Referring to FIG. 3D, the CBL module 360 takes as input a tensor 361. The tensor 361 is passed to a convolutional layer 362 to produce tensor 363. When the convolutional layer 362 has a stride of one and padding is set to k samples, with a convolutional kernel of size 2k+1, the tensor 363 has the same spatial dimensions as the tensor 361. When the convolution layer 362 has a larger stride, such as two, the tensor 363 has smaller spatial dimensions compared to the tensor 361, for example, halved in size for the stride of two. Regardless of the stride, the size of channel dimension of the tensor 363 may vary compared to the channel dimension of the tensor 361 for a particular CBL block. The tensor 363 is passed to a batch normalisation module 364 which outputs a tensor 365. The batch normalisation module 364 normalises the input tensor 363, and applies a scaling factor and offset value to produce the output tensor 365. The scaling factor and offset value are derived from a training process. The tensor 365 is passed to a leaky rectified linear activation (“LeakyReLU”) module 366 to produce a tensor 367. The module 366 provides a ‘leaky’ activation function whereby positive values in the tensor are passed through and negative values are severely reduced in magnitude, for example,× to 0.1X of the former value.

Returning to FIG. 3A, the tensor 316 is passed from the CBL block 314 to a residual block 11 module 320. The module 320 contains a sequential concatenation of three residual blocks, containing 1, 2, and 8 residual units internally, respectively.

A residual block, such as present in the module 320, is described with reference to a ResBlock 340 as shown in FIG. 3B. The ResBlock 340 receives a tensor 341. The tensor 341 is zero-padded by a zero-padding module 342 to produce a tensor 343. The tensor 343 is passed to a CBL module 344 to produce a tensor 345. The tensor 345 is passed to a residual unit 346, of which the residual block 340 includes a series of concatenated residual units. The last residual unit of the residual units 346 outputs a tensor 347.

A residual unit, such as the unit 346, is described with reference to a ResUnit 350 as shown in FIG. 3C. The ResUnit 350 takes a tensor 351 as input. The tensor 351 is passed to a CBL module 352 to produce a tensor 353. The tensor 353 is passed to a second CBL unit 354 to produce a tensor 355. An add module 356 sums the tensor 355 with the tensor 351 to produce a tensor 357. The add module 356 may also be referred to as a ‘shortcut’ as the input tensor 351 substantially influences the output tensor 357. For an untrained network, ResUnit 350 acts to pass-through tensors. As training is performed, the CBL modules 352 and 354 act to deviate the tensor 357 away from the tensor 351 in accordance with training data and ground truth data.

Returning to FIG. 3A, the Res11 module 320 outputs a tensor 322. The tensor 322 is output from the backbone module 310 as one of the layers and also provided to a Res8 module 324. The Res8 module 324 is a residual block (i.e., 340), which includes eight residual units (i.e. 350). The Res8 module 324 produces a tensor 326. The tensor 326 is passed to a Res4 module 328 and output from the backbone module 310 as one of the layers. The Res4 module 328 is a residual block (i.e., 340), which includes four residual units (i.e., 350). The Res4 module 324 produces a tensor 329. The tensor 329 is output from the backbone module 310 as one of the layers.

Collectively, the layer tensors 322, 326, and 329 are output as the tensors 115. The backbone CNN 310 may take as input a video frame of resolution 1088×608 and produce three tensors, corresponding to three layers, with the following dimensions: [1, 256, 76, 136], [1, 512, 38, 68], [1, 1024, 19, 34]. Another example of the three tensors corresponding to three layers may be [1, 512, 34, 19], [1, 256, 68, 38], [1, 128, 136, 76] which are respectively separated at 75th network layer, 90th network layer, and 105th network layer in the CNN 310. Each tensor can have a different resolution to the next tensor. The resolution of each tensors can double in height and width between respective tensors. In forming the output tensors 115, the layer tensors 322, 326, and 329 provide a hierarchical representation of the frame data including data of feature maps for encoding to the bitstream. The separating points depend on the CNN 310.

FIG. 4 is a schematic block diagram showing functional modules of an alternative backbone portion 400 of a CNN, which may serve as the CNN backbone 114. The backbone portion 400 implements a residual network with feature pyramid network (‘ResNet FPN’) and is an alternative to the CNN backbone 114. Frame data 113 is input and passes through a stem network 408, a res2 module 412, a res3 module 416, a res4 module 420, a res5 module 424, and a max pool module 428 via tensors 409, 413, 417, 425, with the max pool module 428 producing P6 tensor 429 as output.

The stem network 408 includes a 7×7 convolution with a stride of two (2) and a max pooling operation. The res2 module 412, the res3 module 416, the res4 module 420, and the res5 module 424 perform convolution operations, LeakyReLU activations. Each module 412, 416, 420 and 424 also performs one halving of the resolution of the processed tensors via a stride setting of two. The tensors 413, 417, 421, and 425 are passed to 1×1 lateral convolution modules 446, 444, 442, and 440 respectively. The modules 440, 442, 444, and 446 produce tensors 441, 443, 445, 447, respectively. The tensor 441 is passed to a 3×3 output convolution module 470, which produces an output tensor P5 471. The tensor 441 is also passed to upsampler module 450 to produce an upsampled tensor 451. A summation module 460 sums the tensors 443 and 451 to produce a tensor 461. The tensor 461 is passed to an upsampler module 452 and a 3×3 lateral convolution module 472. The module 472 outputs a P4 tensor 473. The upsampler module 452 produces an upsampled tensor 453. A summation module 462 sums tensors 445 and 453 to produce a tensor 463. The tensor 463 is passed to a 3×3 lateral convolution module 474 and an upsampler module 454. The module 474 outputs a P3 tensor 475. The upsampler module 454 outputs an upsampled tensor 455. A summation module 464 sums the tensors 447 and 455 to produce tensor 465, which is passed to a 3×3 lateral convolution module 476. The module 476 outputs a P2 tensor 477. The upsampler modules 450, 452, and 454 use nearest neighbour interpolation for low computational complexity. The tensors 429, 471, 473, 475, and 477 form the output tensor 115 of the CNN backbone 400. In forming the output tenors 115, the FPN of tensors 429, 471, 473, 475, and 477 provide a hierarchical representation of the frame data including data of feature maps for encoding to the bitstream.

FIG. 5 is a schematic block diagram showing one type of bottleneck encoder 500, which may serve as the bottleneck encoder 116 or, when implemented with support for back propagation of gradients with weight updating, as the trainable bottleneck encoder 170. FIG. 7A shows a packing arrangement of feature maps from compressed tensors into a monochrome video frame.

FIG. 14 shows the method 1400 for reducing tensor dimensionality using the bottleneck encoder 500 of FIG. 5. The method 1400 may be implemented using apparatus such as a configured FPGA, an ASIC, or an ASSP. Alternatively, as described below, the method 1400 may be implemented by the source device 110, as one or more software code modules of the application programs 233, under execution of the processor 205. The software code modules of the application programs 233 implementing the method 1400 may be resident, for example, in the hard disk drive 210 and/or the memory 206. The method 1400 is repeated for each frame of compressed data in the bitstream 123. The method 1400 may be stored on computer-readable storage medium and/or in the memory 206.

The method 1400 begins at a select first FPN tensors step 1410. The bottleneck encoder 500 receives FPN tensors 501, corresponding to the tensors 115, and operates to restrict the dimensionality of the received tensors to fewer layers and having reduced spatial size in accordance with the method 1400. Applying a bottleneck encoder and decoder between the first portion (backbone 114) and the second portion (head 152) of a separated neural network enables a reduction in the spatial area in a frame of packed tensor data. The reduction in spatial area is achieved by using the interface between the bottleneck encoder and the bottleneck decoder as the split point of the first and second portions (114 and 152) of the neural network. The bottleneck encoder 116 acts as additional layers appended to the neural network first portion and the bottleneck decoder 150 acts as additional layers prepended to the neural network second portion. The tensors 115 can be considered to include a first set of tensors (for example P2, P3, P4 and P5) and a second set of tensors (for example P2 and P3), in which feature maps of the second set of tensors are a subset of the first set of tensors. Feature maps of the second set of tensors include tensors with larger spatial resolutions among the spatial resolutions of the feature maps of the first set of tensors. A first tensor (for example P2 or P3) belonging to both the first set of tensors and the second set of tensors is represented in the base layer (first unit of information) and the enhancement layer (second unit of information). A second tensor (for example P4 or P5) belonging to the first set of tensors but not belonging to the second set of tensors is represented in the base layer (first unit of information) but not the enhancement layer (second unit of information). The first unit of information typically encodes all tensors within the tensors 115, that is, P2-P5 and the second unit of information typically encodes a subset of tensors encoded by the first unit of information (for example P2 and P3), the subset containing tensors with larger feature map resolution among the feature map resolutions of the P2-P5 tensors. Other combinations of sets of tensors are also possible. The second unit of information could, for example, only encode the tensor P2 or could encode the tensors P2-P4. The first unit of information could include only tensors P2-P4 with the tensor P5 separately packed into the frame 700 for encoding into the bitstream 123. When the first unit of information includes tensors P2-P4 then the second unit of information could include tensor P2 or tensors P2 and P3.

The sensitivity of the task result to the bottleneck depends on the nature of the task. For object detection, there is less spatial sensitivity and so spatial downsampling of larger layers of the FPN is less detrimental to the resulting mAP. Instance segmentation and the resulting segmentation maps are more sensitive to a loss of spatial detail and so benefit from less severe spatial downsampling, especially for spatially larger tensors of the FPN. In the arrangements described, the bottleneck encoder 500 operates at two scales. A first scale covers all FPN layers and a second scale covers a subset of the FPN layers. The second scale may include the larger layers, for example P2 and P3 (502 and 503) thus providing additional fidelity for these higher-resolution feature maps. The input FPN tensors 501 comprise layers P2 502, P3 503, P4 504, and P5 505. The spatial resolutions of the layers P2-P4 (502, 503, 504) are power-of-two multiples of the spatial resolution of P5 505. With P5 505 having width and height (w,h), P2-P4 (502, 503, 504) have dimensions (8w,8h), (4w,4h), (2w,2h), respectively. In other words, respective tensors have resolutions forming an exponential sequence with a doubling in width and height between successive tensors. The layers P2-P5 each have 256 channels. Although the base layer is described as mandatory and the enhancement layer as optional (dependent on circumstances such as fidelity), an arrangement whereby a second enhancement layer is included is possible. The second enhancement layer is capable of being included only when the enhancement layer is included and the tensors of the second enhancement layer are a subset of the tensors of the first enhancement layer (as described above). For example, the tensors of the second subset may be for P2 only if the (first) enhancement layer relate to P2 and P3. In other words, the second enhancement layer provides further fidelity for specific tensors as already enhanced by the first enhancement layer. Cascading enhancement layers provides further flexibility in providing incremental quality improvement by including tensors of each progressive enhancement layer in the packed frame.

In the example described above, the inputs P2 to P5 correspond with the hierarchical feature pyramid network outputs (P2 477, P3 475, P4 473 and P5 471) generated by the CNN backbone 400 of FIG. 4. If the CNN backbone is implemented based on FIG. 3A and outputs tensors 329, 326 and 322, the tensors 329, 326 and 322 are derived into two sets of tensors, a first group having one FPN layer 329 and the second group having two FPN layers 322 and 326. The first group, having one FPN layer 329, has the smallest spatial resolution and does not require operation of an MSFF module 510 in the bottleneck encoder 116, with the tensor 329 passed directly to the SSFC encoder 550 as a tensor 529. The second group is processed by the MSFF 510 in the bottleneck encoder 116 with the tensor 326 passed in (input) as the tensor 503 and the tensor 322 passed in as the tensor 502. At the step 1410 the bottleneck encoder 500, under execution of the processor 205, selects multiple tensors adjacent among the tensors 501 as the first plurality of tensors, such as four tensors P2 502, P3 503, P4 504 and P5 505. The tensors 501 form a hierarchical representation of the frame data 113 that results from application of a FPN to the frame data 113. Use of stride equal to two convolution stages in the FPN, i.e., at modules 412, 416, 420, and 424, results in the spatial dimensions of tensors among the tensors 501 halving in width and height with each respective tensor, when ordered according to decompositional level, for example, from P2 to P5. A degree of inter-layer correlation exists among the layers P2 to P5 of the tensors 501 despite the layers having different spatial resolution. Exploiting inter-layer correlation permits a channel count reduction relative to a concatenation of tensors across layers, provided the tensors are firstly spatially scaled to the same resolution, for example, the smallest resolution among the tensors to be combined. Combining tensors of greatly differing spatial resolution typically results in a relatively high loss of detail in the higher-resolution tensor due to the higher ratio of the downsampling operation. For example, scaling P2 502 to P5 505 requires reducing width and height to one eighth of their former values, for an area reduction to one sixty-fourth of the P2 502 area. For tasks dependent on spatial detail, such as instance segmentation, mAP is degraded. Reductions in mAP due to such high downsampling of larger layers occurs for detection of small objects where the higher resolution layers are relied upon by the network head. Control in the processor 205 progresses from the step 1410 to a generate first bottleneck tensor step 1420.

At the step 1420 the MSFF module 510 (see FIG. 5), under execution of the processor 205, combines each tensor of first set of tensors, i.e., 502, 503, 504, 505, to produce the combined tensor 529. The combined tensor 529 is encoded as a compressed tensor 557. The combined tensor 529 forms a ‘base layer’ representation of the FPN layer tensors. Downsample modules 522, 522a, 522b operates on the tensors having larger spatial scale, i.e., P4 504 at 2h, 2w, 256, and P3 503 at 4h, 4w, 256, and P2 502 at 8h, 8w, 256, respectively. Modules 522, 522a, and 522b downsample to match the spatial scale of the smallest tensor, i.e., P5 505 at h, w, 256, producing downscaled P5 tensors 523, 523a, 523b, respectively. A concatenation module 524 performs a channel-wise concatenation of the tensors 505, 523, 523a, and 523b to produce concatenated tensor 525, of dimensions h, w, 512. The concatenated tensor 525 is passed to a squeeze and excitation (SE) module 526 to produce a tensor 527. The SE module 526 sequentially performs a global pooling, a fully-connected layer with reduction in channel count, a rectified linear unit activation, a second fully-connected layer restoring the channel count, and a sigmoid activation function to produce a scaling tensor. The tensor 525 is scaled according to the scaling tensor to produce the output as the tensor 527. The SE block 526 is capable of being trained to adaptively alter the weighting of different channels in the tensor passed through, based on the first fully-connected layer output. The first fully-connected layer output reduces each feature map for each channel to a single value. Each single value is then passed through the non-linear activation unit (ReLU) to create a conditional representation of the unit, suitable for weighting of other channels, with restoration to the full channel count performed by the second fully-connected layer. The SE block 526 is thus capable of extracting non-linear inter-channel correlation in producing the tensor 527 from the tensor 525, to a greater extent than is possible purely with convolutional (linear) layers. As the tensors 525 and 527 contain 512 channels, a result of the concatenation of two FPN layers, the decorrelation achieved by the SE block 526 spans the two FPN layers P5 and P4.

The tensor 527 is passed to a convolutional layer 528. The convolutional layer 528 implements one or more convolutional layers to produce the first combined tensor 529, with channel count reduced to F channels, typically 256 channels (i.e., F=256).

Operation of an SSFC encoder 550 reduces the dimensionality of the combined tensor 529 to produce the compressed tensor 557. The combined tensor 529 is passed to a convolution layer 552 of the encoder 550. The encoder 550 produces a tensor 553. The tensor 553 has a channel count reduced from 256 to a smaller value C′, such as 64. The value 96 may also be used for C′, resulting in a larger area requirement for the packed frame, to be described with reference to FIG. 7A. The tensor 553 is passed to a batch normalisation module 554 to produce tensor 555. The batch normalised tensor 555 has the same dimensionality as the tensor 553. The tensor 555 is passed to a tanh layer 556. The tanh layer 556 implements a hyperbolic tangent (tanh) layer, as per the layer 536, to produce the compressed tensor 557. The compressed tensor 557 has the same dimensionality as the tensor 553. The step 1420 operates to derive or decode a first unit of information from the tensors 501. Control in the processor 205 progresses from the step 1420 to a determine second bottleneck tensor present step 1430.

At the step 1430 the processor 205 determines whether to generate and encode a second set of tensors or not, the second set of encoded tensors indicated as a second bottleneck tensor 537. The determination at step 1430 can depend on at least one of configuration of the system 100 and the machine task to be completed at the head network 152. For example, if the system 100 is configured to perform a task requiring a high degree of spatial acuity, such as instance segmentation, the determination to include the enhancement layer may be made, permitting a higher mAP to be achieved by the destination device 140. When the system 100 is configured to perform a task requiring a lower degree of spatial acuity (or ‘regular quality’), such as object detection, the determination to omit the enhancement layer may be made, saving the bitrate expense of the additional layer. If the system 100 is configured for ‘regular quality’ operation, the second set of tensors is not generated and the system 100 is said to operate in a ‘first mode’. If the system 100 is configured for ‘high quality’ operation, the second set of tensors is generated and the system 100 is set to operate in a ‘second mode’. If the machine task being performed by the destination device 140 requires relatively high retention of spatial detail (for example) instance segmentation, a determination to include the second set of tensors is made. Control in the processor 205 progresses from the step 1420 to an encode second bottleneck tensor present indication step 1440. In an arrangement of the system 100, the consumer of the task result 153, such as a human operator or an algorithm aggregating tasks from many networks, may determine a need for higher quality and signal to the source device 110 via an out-of-band communication channel an indication to include (or omit) the enhancement layer. One example arrangement would involve the neural network head 152 of the destination device 140 performing a generic person detection, and upon detection of a person signalling to the source device 110 to include the enhancement layer, then performing a more capable alternative network head as the network head 152. The more capable alternative network head may perform an object detection task with greater specificity, for example identifying a person of interest.

At the step 1440 the entropy encoder 838, under execution of the processor 205, encodes a flag indicating the decision made at the step 1420 to operate in the first mode (base layer only) or the second mode (base layer and enhancement layer) into the bitstream 123. The flag may be included in the SEI message 744 as flag 751. Control in the processor 205 progresses from the step 1430 to second bottleneck tensor present test step 1450.

At the step 1450, the software 233 determines whether to generate the second bottleneck tensor 537. If a flag is present indicating that the second bottleneck tensor is to be generated (“PRESENT” at step 150), control in the processor 205 progresses from the step 1450 to an select second FPN tensors step 1460. Otherwise, if the flag is not present (“ABSENT” at step 1450), the method 1400 terminates. Termination of the method 400 on implementation of the step 1450 (“ABSENT” at step 1450) can be considered a first mode of operation of the encoder 500. Proceeding from step 1450 to step 1460 and the following steps can be considered a second mode of operation of the encoder 500. The step 1450 accordingly determines, based on at least one of a quality configuration and a machine task to be completed, whether to operate in the first mode or the second mode. As per the example above, operation in the second mode is determined if the machine task is to be completed is instance segmentation.

At the step 1460 the second set of FPN tensors are selected. The second set of FPN tensors are a subset of the tensors selected as part of the step 1410 and generally include tensors having larger spatial resolution and adjacent spatial scale, for example P2 502 and P3 503. A switch 570 is activated causing assignment of the second set of FPN tensors to subsequent processing stages. In particular the tensor 502 is provided as 502a and the tensor 503 is provided as 503a on closing of the switch 270. Control in the processor 205 progresses from the step 1460 to a generate second bottleneck tensor step 1470.

At the step 1470 the MSFF module 510, under execution of the processor 205, combines each tensor of the second tensors, i.e., 502a, 503a, to produce a combined tensor 519, as described with reference to FIG. 5. The combined tensor 519 provides an ‘enhancement layer’ representation in the form of a subset of the FPN layer tensors. A downsample module 512 operates on the tensor having larger spatial scale, i.e., P2 502 at 8h, 8w, 256, downsampling to match the spatial scale of the smaller tensor, i.e., P3 503 at 4h, 4w, 256, producing downscaled P2 tensor 513. A concatenation module 514 performs a channel-wise concatenation of the tensors 503a and 513 to produce a concatenated tensor 515. The tensor 515 has dimensions 4h, 4w, 512. The concatenated tensor 515 is passed to a squeeze and excitation (SE) module 516 to produce a tensor 517. The SE module 516 operates in the same manner as described with reference to the SE module 526. The tensor 517 is passed to a convolutional layer 518. The convolutional layer 518 operates in a similar manner to the convolutional layer 528 to produce a second combined tensor 519. The second combined tensor 519 has a channel count reduced to F channels, typically 256 channels (i.e., F=256). As a result of the modules 512, 514, 516 and 518, tensors of two FPN layers are reduced to a single tensor, having the same channel count as the input FPN layer tensors and a spatial resolution of the smaller of the two FPN layer tensors. The dimensionality reduction is achieved with several network layers and relies upon training the layers (for example layers of 516 and 518) rather than on-the-fly determination of correlation to exploit.

A SSFC encoder 530 operates to further reduce the dimensionality of the combined tensor 519 to produce a compressed tensor 537. The combined tensor 519 is passed to a convolution layer 532 to produce a tensor 533. The tensor 533 has channel count reduced from 256 to a smaller value C′, such as 64. The tensor 533 is passed to a batch normalisation module 534 to produce tensor 535. The batch normalised tensor 535 has the same dimensionality as the tensor 533. The tensor 535 is passed to a tanh layer 536 to produce the compressed tensor 537. The compressed tensor 537 has the same dimensionality as the tensor 533. Use of a hyperbolic tangent (tanh) layer compresses the dynamic range of values within the tensor 537 to [−1, 1], removing outlier values. The layers 532, 534 and 536 operate in a similar manner to the layers 552, 554 and 556, respectively.

Compressed tensors 557 and 537 provide units of information of feature maps of the frame data 113 as obtained using convolutional operations of (i) the MSFF 510 and the SSFC encoder 550 on the tensors 505, 504, 503 and 502, and (if present) (ii) the MSFF 510 and the SSFC encoder 530 on the tensors 503 and 502. The compressed tensors 557 and 537 provide a set of tensors 560 corresponding to the bottleneck encoded tensors 117. If the encoder 500 is operating in the first mode (“ABSENT” at 1450 and switch 570 closed), the tensors 557 provide the tensor 560. The tensors 560 are provided as the tensor 117 to the quantise and pack module 184 for encoding into the bitstream by the video encoder 120.

In an arrangement of the bottleneck encoder 500 the tanh modules 536 and 556 are omitted, resulting in the tensors 535 and 555 being passed along as tensors 537 and 557, respectively. In other words, the output 537 in arrangements omitting 536 relates to the combined tensor 519 being applied to the convolutional layer 532 and the batch normalisation layer. The output 557 in arrangements omitting 556 relates to the combined tensor 529 being applied to the convolutional layer 532 and the batch normalisation layer. Omitting the tanh modules results in preservation of outlier or large magnitude values, which experiments found make a disproportionate contribution to the final task performance in the head 152.

An example single monochrome video frame, the frame 700, is shown in FIG. 7A.

The frame 700 corresponds to the packed and quantised feature map data 185. The nature of tanh in removing outliers results in a distribution amenable to linear quantisation to the bit depth of the frame 700. Channels of the compressed tensor 557 are packed as feature maps of a particular size, such as a feature map 712 in a region 714 of the frame 700. Channels of the compressed tensor 537 (if present as determined at the step 1430) are packed as feature maps of a different size, such as a feature map 710, in a region 716 of the frame 700. One channel of the compressed tensor 537 corresponds to one feature map indicated by one rectangular area, such as the area 710. One channel of the compressed tensor 557 corresponds to one feature map indicated by one rectangular area, such as the area 712. The region 714 and the region 716 (if present) form a packed representation of the tensors 557 and 537, which once compressed by the video encoder 120 form a first unit of information and a second unit of information, respectively. The first and second units of information may be stored in a manner permitting independent encoding and decoding, such as by using separate slices, tiles, or subpictures of the frame 700 or separate pictures entirely. The video decoder 148 may only decode the region 714, that is, the first unit of information, and discard the region 716, that is, the second unit of information, and still provide tensors 151 to the CNN head 152 to produce a task result, albeit with lower fidelity than achievable had the region 716 or second unit of information been decoded.

FIG. 7B is a schematic block diagram showing a bitstream 723, which may be a portion of the bitstream 123, encoding tensor data. Compressed frame n 742 contains compressed tensors arranged as described with reference to FIG. 7A. An SEI message 744 includes a weight update flag 750 and, if indicated by the weight updated flag 750, neural network weights 752. Compressed frame N+1 746 contains compressed tensors using the weights as derived from the neural network weights 752. Presence of the second bottleneck tensor (such as 537) may be encoded in the SEI message 744 as a presence flag 751.

FIG. 8 is a schematic block diagram showing functional modules of the video encoder 120, also referred to as a feature map encoder. The video encoder 120 encodes the packed feature map frame 185, shown as frame 700 in the example of FIG. 7A, to produce the video bitstream 121. Generally, data passes between functional modules within the video encoder 120 in groups of samples or coefficients, such as divisions of blocks into sub-blocks of a fixed size, or as arrays. The video encoder 120 may be implemented using a general-purpose computer system 200, as shown in FIGS. 2A and 2B, where the various functional modules may be implemented by dedicated hardware within the computer system 200, by software executable within the computer system 200 such as one or more software code modules of the software application program 233 resident on the hard disk drive 205 and being controlled in its execution by the processor 205. Alternatively, the video encoder 120 may be implemented by a combination of dedicated hardware and software executable within the computer system 200.

The video encoder 120 and the described methods may alternatively be implemented in dedicated hardware, such as one or more integrated circuits performing the functions or sub functions of the described methods. Such dedicated hardware may include graphic processing units (GPUs), digital signal processors (DSPs), application-specific standard products (ASSPs), application-specific integrated circuits (ASICs), field programmable gate arrays (FPGAs) or one or more microprocessors and associated memories. In particular, the video encoder 120 comprises modules 810-890 which may each be implemented as one or more software code modules of the software application program 233.

Although the video encoder 120 of FIG. 8 is an example of a versatile video coding (VVC) video encoding pipeline, other video coding standards or implementations may also employ the processing stages of modules 810-890. The frame data 185 (and bitstream 121) may also be read from (or written to) memory 206, the hard disk drive 210, a CD-ROM, a Blu-ray disk™ or other computer readable storage medium. Additionally, the frame data 185 (and bitstream 121) may be received from (or transmitted to) an external source, such as a server connected to the communications network 220 or a radio-frequency receiver. The communications network 220 may provide limited bandwidth, necessitating the use of rate control in the video encoder 120 to avoid saturating the network at times when the frame data 185 is difficult to compress. The frame data 185 may be in any chroma format and bit depth supported by the profile in use, for example 4:0:0, 4:2:0 for the “Main 10” profile of the VVC standard, at eight (8) to ten (10) bits in sample precision.

A block partitioner 810 firstly divides the frame data 185 into CTUs, generally square in shape and configured such that a particular size for the CTUs is used. The maximum enabled size of the CTUs may be 32×32, 64×64, or 128×128 luma samples for example, configured by a ‘sps_log2_ctu_size_minus5’ syntax element present in the ‘sequence parameter set’. The CTU size also provides a maximum CU size, as a CTU with no further splitting will contain one CU. The block partitioner 810 further divides each CTU into one or more CBs according to a luma coding tree and a chroma coding tree. The luma channel may also be referred to as a primary colour channel. Each chroma channel may also be referred to as a secondary colour channel. The CBs have a variety of sizes, and may include both square and non-square aspect ratios. However, in the VVC standard, CBs, CUs, PUs, and TUs always have side lengths that are powers of two. Thus, a current CB, represented as 812, is output from the block partitioner 810, progressing in accordance with an iteration over the one or more blocks of the CTU, in accordance with the luma coding tree and the chroma coding tree of the CTU.

The CTUs resulting from the first division of the frame data 185 may be scanned in raster scan order and may be grouped into one or more ‘slices’. A slice may be an ‘intra’ (or ‘I’) slice. An intra slice (I slice) indicates that every CU in the slice is intra predicted. Generally, the first picture in a coded layer video sequence (CLVS) contains only I slices, and is referred to as an ‘intra picture’. The CLVS may contain periodic intra pictures, forming ‘random access points’ (i.e., intermediate frames in a video sequence upon which decoding can commence). Alternatively, a slice may be uni-or bi-predicted (‘P’ or ‘B’ slice, respectively), indicating additional availability of uni-and bi-prediction in the slice, respectively.

The video encoder 120 encodes sequences of pictures according to a picture structure. One picture structure is ‘low delay’, in which case pictures using inter-prediction may only reference pictures occurring previously in the sequence. Low delay enables each picture to be output as soon as the picture is decoded, in addition to being stored for possible reference by a subsequent picture. Another picture structure is ‘random access’, whereby the coding order of pictures differs from the display order. Random access allows inter-predicted pictures to reference other pictures that, although decoded, have not yet been output. A degree of picture buffering is needed so the reference pictures in the future in terms of display order are present in the decoded picture buffer, resulting in a latency of multiple frames.

When a chroma format other than 4:0:0 is in use, in an I slice, the coding tree of each CTU may diverge below the 64×64 level into two separate coding trees, one for luma and another for chroma. Use of separate trees allows different block structure to exist between luma and chroma within a luma 64×64 area of a CTU. For example, a large chroma CB may be collocated with numerous smaller luma CBs and vice versa. In a P or B slice, a single coding tree of a CTU defines a block structure common to luma and chroma. The resulting blocks of the single tree may be intra predicted or inter predicted.

In addition to a division of pictures into slices, pictures may also be divided into ‘tiles’. A tile is a sequence of CTUs covering a rectangular region of a picture. CTU scanning occurs in a raster-scan manner within each tile and progresses from one tile to the next. A slice can be either an integer number of tiles, or an integer number of consecutive rows of CTUs within a given tile.

For each CTU, the video encoder 120 operates in two stages. In the first stage (referred to as a ‘search’ stage), the block partitioner 810 tests various potential configurations of a coding tree. Each potential configuration of a coding tree has associated ‘candidate’ CBs. The first stage involves testing various candidate CBs to select CBs providing relatively high compression efficiency with relatively low distortion. The testing stage generally involves a Lagrangian optimisation whereby a candidate CB is evaluated based on a weighted combination of rate (i.e., coding cost) and distortion (i.e., error with respect to the input frame data 185). ‘Best’ candidate CBs (i.e., the CBs with the lowest evaluated rate/distortion) are selected for subsequent encoding into the bitstream 121. Included in evaluation of candidate CBs is an option to use a CB for a given area or to further split the area according to various splitting options and code each of the smaller resulting areas with further CBs, or split the areas even further. As a consequence, both the coding tree and the CBs themselves are selected in the search stage.

The video encoder 120 produces a prediction block (PB), indicated by an arrow 820, for each CB, for example, CB 812. The PB 820 is a prediction of the contents of the associated CB 812. A subtracter module 822 produces a difference, indicated as 824 (or ‘residual’, referring to the difference being in the spatial domain), between the PB 820 and the CB 812. The difference 824 is a block-size difference between corresponding samples in the PB 820 and the CB 812. The difference 824 is transformed, quantised and represented as a transform block (TB), indicated by an arrow 836. The PB 820 and associated TB 836 are typically chosen from one of many possible candidate CBs, for example, based on evaluated cost or distortion.

A candidate coding block (CB) is a CB resulting from one of the prediction modes available to the video encoder 120 for the associated PB and the resulting residual. When combined with the predicted PB in the video encoder 120, the TB 836 reduces the difference between a decoded CB and the original CB 812 at the expense of additional signalling in the bitstream.

Each candidate coding block (CB), that is prediction block (PB) in combination with a transform block (TB), thus has an associated coding cost (or ‘rate’) and an associated difference (or ‘distortion’). The distortion of the CB is typically estimated as a difference in sample values, such as a sum of absolute differences (SAD), a sum of squared differences (SSD) or a Hadamard transform applied to the differences. The estimate resulting from each candidate PB may be determined by a mode selector 886 using the difference 824 to determine a prediction mode 887. The prediction mode 887 indicates the decision to use a particular prediction mode for the current CB, for example, intra-frame prediction or inter-frame prediction. Estimation of the coding costs associated with each candidate prediction mode and corresponding residual coding may be performed at significantly lower cost than entropy coding of the residual. Accordingly, a number of candidate modes may be evaluated to determine an optimum mode in a rate-distortion sense even in a real-time video encoder.

Determining an optimum mode in terms of rate-distortion is typically achieved using a variation of Lagrangian optimisation.

Lagrangian or similar optimisation processing can be employed to both select an optimal partitioning of a CTU into CBs (by the block partitioner 810) as well as the selection of a best prediction mode from a plurality of possibilities. Through application of a Lagrangian optimisation process of the candidate modes in the mode selector module 886, the intra prediction mode with the lowest cost measurement is selected as the ‘best’ mode. The lowest cost mode includes the selected secondary transform index 888, which is also encoded in the bitstream 121 by an entropy encoder 838.

In the second stage of operation of the video encoder 120 (referred to as a ‘coding’ stage), an iteration over the determined coding tree(s) of each CTU is performed in the video encoder 120. For a CTU using separate trees, for each 64×64 luma region of the CTU, a luma coding tree is firstly encoded followed by a chroma coding tree. Within the luma coding tree, only luma CBs are encoded and within the chroma coding tree only chroma CBs are encoded. For a CTU using a shared tree, a single tree describes the CUS (i.e., the luma CBs and the chroma CBs) according to the common block structure of the shared tree.

The entropy encoder 838 supports bitwise coding of syntax elements using variable-length and fixed-length codewords, and an arithmetic coding mode for syntax elements. Portions of the bitstream such as ‘parameter sets’, for example, sequence parameter set (SPS) and picture parameter set (PPS) use a combination of fixed-length codewords and variable-length codewords. Slices, also referred to as contiguous portions, have a slice header that uses variable length coding followed by slice data, which uses arithmetic coding. The slice header defines parameters specific to the current slice, such as slice-level quantisation parameter offsets. For a given slice, the slice data includes the syntax elements of each CTU in the slice. Use of variable length coding and arithmetic coding requires sequential parsing within each portion of the bitstream. The portions may be delineated with a start code to form ‘network abstraction layer units’ or ‘NAL units’. Arithmetic coding is supported using a context-adaptive binary arithmetic coding process.

Arithmetically coded syntax elements consist of sequences of one or more ‘bins’. Bins, like bits, have a value of ‘0’ or ‘1’. However, bins are not encoded in the bitstream 121 as discrete bits. Bins have an associated predicted (or ‘likely’ or ‘most probable’) value and an associated probability, known as a ‘context’. When the actual bin to be coded matches the predicted value, a ‘most probable symbol’ (MPS) is coded. Coding a most probable symbol is relatively inexpensive in terms of consumed bits in the bitstream 121, including costs that amount to less than one discrete bit. When the actual bin to be coded mismatches the likely value, a ‘least probable symbol’ (LPS) is coded. Coding a least probable symbol has a relatively high cost in terms of consumed bits. The bin coding techniques enable efficient coding of bins where the probability of a ‘0’ versus a ‘1’ is skewed. For a syntax element with two possible values (i.e., a ‘flag’), a single bin is adequate. For syntax elements with many possible values, a sequence of bins is needed.

The decomposition of the value of a syntax element into a sequence of one or more bins is referred to as a ‘binarisation’ of the syntax element. A binarization may include conditional presence of later bins on the values of earlier bins, enabling variable bin length binarisations. Additionally, each bin may be associated with more than one context. The selection of a context for a bin is referred to as ‘context modelling’. Context modelling may be dependent on earlier bins in the syntax element, the bin values of neighbouring syntax elements (i.e., those from neighbouring blocks) and the like. Each time a context-coded bin is encoded, the context that was selected for that bin (if any) is updated in a manner reflective of the new bin value. As such, the binary arithmetic coding scheme is said to be adaptive.

Also supported by the entropy encoder 838 are bins that lack a context, referred to as “bypass bins”. Bypass bins are coded with an equiprobable distribution between a ‘0’ and a ‘1’. Thus, each bin has a coding cost of one bit in the bitstream 121 and are generally used where there is no (or none that is readily exploited) statistical skew in the probability distribution of bin values. The absence of a context saves memory and reduces complexity, and thus bypass bins are used where the distribution of values for the particular bin is not skewed. One example of an entropy coder employing context and adaption is known in the art as CABAC (context adaptive binary arithmetic coder) and many variants of this coder have been employed in video coding.

The entropy encoder 838 encodes a quantisation parameter 892 and, if in use for the current CB, the secondary transform index 888, using a combination of context-coded and bypass-coded bins. The quantisation parameter 892 is encoded using a ‘delta QP’ generated by a QP controller module 890. The delta QP is signalled at most once in each area known as a ‘quantisation group’. The quantisation parameter 892 is applied to residual coefficients of the luma CB. An adjusted quantisation parameter is applied to the residual coefficients of collocated chroma CBs. The adjusted quantisation parameter may include mapping from the luma quantisation parameter 892 according to a mapping table and a CU-level offset, selected from a list of offsets. The secondary transform index 888 is signalled when the residual associated with the transform block includes significant residual coefficients only in those coefficient positions subject to transforming into primary coefficients by application of a secondary transform.

Residual coefficients of each TB associated with a CB are coded using a residual syntax. The residual syntax is designed to efficiently encode coefficients with low magnitudes, using mainly arithmetically coded bins to indicate significance of coefficients, along with lower-valued magnitudes and reserving bypass bins for higher magnitude residual coefficients. Accordingly, residual blocks comprising very low magnitude values and sparse placement of significant coefficients are efficiently compressed. Moreover, two residual coding schemes are present. A regular residual coding scheme is optimised for TBs with significant coefficients predominantly located in the upper-left corner of the TB, as is seen when a transform is applied. A transform-skip residual coding scheme is available for TBs where a transform is not performed and is able to efficiently encode residual coefficients regardless of their distribution throughout the TB.

A multiplexer module 884 outputs the PB 820 from an intra-frame prediction module 864 according to the determined best intra prediction mode, selected from the tested prediction mode of each candidate CB. The candidate prediction modes need not include every conceivable prediction mode supported by the video encoder 120. Intra prediction falls into three types, first, “DC intra prediction”, which involves populating a PB with a single value representing the average of nearby reconstructed samples; second, “planar intra prediction”, which involves populating a PB with samples according to a plane, with a DC offset and a vertical and horizontal gradient being derived from nearby reconstructed neighbouring samples. The nearby reconstructed samples typically include a row of reconstructed samples above the current PB, extending to the right of the PB to an extent and a column of reconstructed samples to the left of the current PB, extending downwards beyond the PB to an extent; and, third, “angular intra prediction”, which involves populating a PB with reconstructed neighbouring samples filtered and propagated across the PB in a particular direction (or ‘angle’). In VVC, sixty-five (65) angles are supported, with rectangular blocks able to utilise additional angles, not available to square blocks, to produce a total of eighty-seven (87) angles.

A fourth type of intra prediction is available to chroma PBs, whereby the PB is generated from collocated luma reconstructed samples according to a ‘cross-component linear model’ (CCLM) mode. Three different CCLM modes are available, each mode using a different model derived from the neighbouring luma and chroma samples. The derived model is used to generate a block of samples for the chroma PB from the collocated luma samples. Luma blocks may be intra predicted using a matrix multiplication of the reference samples using one matrix selected from a predefined set of matrices. This matrix intra prediction (MIP) achieves gain by using matrices trained on a large set of video data, with the matrices representing relationships between reference samples and a predicted block that are not easily captured in angular, planar, or DC intra prediction modes.

The module 864 may also produce a prediction unit by copying a block from nearby in the current frame using an ‘intra block copy’ (IBC) method. The location of the reference block is constrained to an area equivalent to one CTU. For a 128×128 CTU, a division into 64×64 quadrants, sometimes referred to as ‘Virtual Pipeline Data Units’ (VPDUs), takes place. The referenceable area includes VPDUs in the current CTU for which all CUs have been decoded and VPDUs in the previous CTU (excluding when the current CTU is the first in a slice, tile, or subpicture), up to a total area of 128×128 luma samples. This area is known as an ‘IBC virtual buffer’ and limits the IBC reference area, thus limiting the required storage. The IBC buffer is populated with reconstructed samples 854 (i.e., prior to loop filtering), and so a separate buffer to the frame buffer 872 is needed. When the CTU size is 128×128 the virtual buffer includes samples only from the CTU adjacent and to the left of the current CTU. When the CTU size is 32 ×32 or 64×64 the virtual buffer includes CTUs from up to the four or sixteen CTUs to the left of the current CTU. Regardless of the CTU size, access to neighbouring CTUs for obtaining samples for IBC reference blocks is constrained by boundaries such as edges of pictures, slices, or tiles. Especially for feature maps of FPN layers having smaller dimensions, use of a CTU size such as 32×32 or 64>64 results in a reference area more aligned to cover a set of previous feature maps. Where feature map placement is ordered based on SAD, SSE or other difference metric, access to similar feature maps for IBC prediction offers coding efficient advantage.

The residual for a predicted block when encoding feature map data is different to the residual seen for natural video. Such natural video is typically captured by an imaging sensor, or screen content, as generally seen in operating system user interfaces and the like. Feature map residuals tend to contain much detail, which is amenable to transform skip coding more than predominantly low-frequency coefficients of various transforms. Experiments show that the feature map residual has enough local similarity to benefit from transform coding. However, the distribution of feature map residual coefficients is not clustered towards the DC (top-left) coefficient of a transform block. In other words, sufficient correlation exists for a transform to show gain when encoding feature map data and this is true also for when intra block copy is used to produce prediction blocks for the feature map data. Accordingly, a Hadamard cost estimate may be used when evaluating residuals resulting from candidate block vectors for intra block copy when encoding feature map data, instead of relying solely on a SAD or SSD cost estimate. SAD or SSD cost estimates tend to select block vectors with residuals more amenable to transform skip coding and may miss block vectors with residuals that would be compactly encoded using transforms. The multiple transform selection (MTS) tool of the VVC standard may be used when encoding feature map data so that, in addition to the DCT-2 transform, combinations of DST-7 and DCT-8 transforms are available horizontally and vertically for residual encoding.

An intra-predicted luma coding block may be partitioned into a set of equal-sized prediction blocks, either vertically or horizontally, which each block having a minimum area of sixteen (16) luma samples. This intra sub-partition (ISP) approach enables separate transform blocks to contribute to prediction block generation from one sub-partition to the next sub-partition in the luma coding block, improving compression efficiency.

Where previously reconstructed neighbouring samples are unavailable, for example at the edge of the frame, a default half-tone value of one half the range of the samples is used. For example, for 10-bit video a value of five-hundred and twelve (512) is used. As no previous samples are available for a CB located at the top-left position of a frame, angular and planar intra-prediction modes produce the same output as the DC prediction mode (i.e. a flat plane of samples having the half-tone value as magnitude).

For inter-frame prediction a prediction block 882 is produced using samples from one or two frames preceding the current frame in the coding order frames in the bitstream by a motion compensation module 880 and output as the PB 820 by the multiplexer module 884. Moreover, for inter-frame prediction, a single coding tree is typically used for both the luma channel and the chroma channels. The order of coding frames in the bitstream may differ from the order of the frames when captured or displayed. When one frame is used for prediction, the block is said to be ‘uni-predicted’ and has one associated motion vector. When two frames are used for prediction, the block is said to be ‘bi-predicted’ and has two associated motion vectors. For a P slice, each CU may be intra predicted or uni-predicted. For a B slice, each CU may be intra predicted, uni-predicted, or bi-predicted.

Frames are typically coded using a ‘group of pictures’ (GOP) structure, enabling a temporal hierarchy of frames. Frames may be divided into multiple slices, each of which encodes a portion of the frame. A temporal hierarchy of frames allows a frame to reference a preceding and a subsequent picture in the order of displaying the frames. The images are coded in the order necessary to ensure the dependencies for decoding each frame are met. An affine inter prediction mode is available where instead of using one or two motion vectors to select and filter reference sample blocks for a prediction unit, the prediction unit is divided into multiple smaller blocks and a motion field is produced so each smaller block has a distinct motion vector. The motion field uses the motion vectors of nearby points to the prediction unit as ‘control points’. Affine prediction allows coding of motion different to translation with less need to use deeply split coding trees. A bi-prediction mode available to VVC performs a geometric blend of the two reference blocks along a selected axis, with angle and offset from the centre of the block signalled. This geometric partitioning mode (“GPM”) allows larger coding units to be used along the boundary between two objects, with the geometry of the boundary coded for the coding unit as an angle and centre offset. Motion vector differences, instead of using cartesian (x, y) offset, may be coded as a direction (up/down/left/right) and a distance, with a set of power-of-two distances supported. The motion vector predictor is obtained from a neighbouring block (‘merge mode’) as if no offset is applied. The current block will share the same motion vector as the selected neighbouring block.

The samples are selected according to a motion vector 878 and reference picture index. The motion vector 878 and reference picture index applies to all colour channels and thus inter prediction is described primarily in terms of operation upon PUs rather than PBs.

The decomposition of each CTU into one or more inter-predicted blocks is described with a single coding tree. Inter prediction methods may vary in the number of motion parameters and their precision. Motion parameters typically comprise a reference frame index, indicating which reference frame(s) from lists of reference frames are to be used plus a spatial translation for each of the reference frames, but may include more frames, special frames, or complex affine parameters such as scaling and rotation. In addition, a pre-determined motion refinement process may be applied to generate dense motion estimates based on referenced sample blocks.

Having determined and selected the PB 820 and subtracted the PB 820 from the original sample block at the subtractor 822, a residual with lowest coding cost, represented as 824, is obtained and subjected to lossy compression. Lossy compression results from a quantisation process of coefficients produced by a forward transform into residual coefficients, ready to be entropy encoded into the bitstream. A forward primary transform module 826 applies a forward transform to the difference 824, converting the difference 824 from the spatial domain to the frequency domain, and producing primary transform coefficients represented by an arrow 828. The largest primary transform size in one dimension is either a 32-point DCT-2 or a 64-point DCT-2 transform, configured by a ‘sps_max_luma_transform_size_64_flag’ in the sequence parameter set. If the CB being encoded is larger than the largest supported primary transform size expressed as a block size (for example 64×64 or 32×32), the primary transform 826 is applied in a tiled manner to transform all samples of the difference 824.

Where a non-square CB is used, tiling is also performed using the largest available transform size in each dimension of the CB. For example, when a maximum transform size of thirty-two (32) is used, a 64×16 CB uses two 32×16 primary transforms arranged in a tiled manner. When a CB is larger in size than the maximum supported transform size, the CB is filled with TBs in a tiled manner. For example, a 128×128 CB with 64-pt transform maximum size is filled with four 64×64 TBs in a 2×2 arrangement. A 64×128 CB with a 32-pt transform maximum size is filled with eight 32×32 TBs in a 2×4 arrangement.

Application of the transform 826 results in multiple TBs for the CB. Where each application of the transform operates on a TB of the difference 824 larger than 32×32, for example 64×64, all resulting primary transform coefficients 828 outside of the upper-left 32×32 area of the TB are set to zero (i.e., discarded). The remaining primary transform coefficients 828 are passed to a quantiser module 834. The primary transform coefficients 828 are quantised according to the quantisation parameter 892 associated with the CB to produce primary transform coefficients 832. In addition to the quantisation parameter 892, the quantiser module 834 may also apply a ‘scaling list’ to allow non-uniform quantisation within the TB by further scaling residual coefficients according to their spatial position within the TB. The quantisation parameter 892 may differ for a luma CB versus each chroma CB. The primary transform coefficients 832 are passed to a forward secondary transform module 830 to produce the transform coefficients represented by the arrow 836 by performing either a non-separable secondary transform (NSST) operation or bypassing the secondary transform. The forward primary transform is typically separable, transforming a set of rows and then a set of columns of each TB. The forward primary transform module 826 uses either a type-II discrete cosine transform (DCT-2) in the horizontal and vertical directions, or bypass of the transform horizontally and vertically, or combinations of a type-VII discrete sine transform (DST-7) and a type-VIII discrete cosine transform (DCT-8) in either horizontal or vertical directions for luma TBs not exceeding 16 samples in width and height. Use of combinations of a DST-7 and DCT-8 is referred to as ‘multi transform selection set’ (MTS) in the VVC standard.

The forward secondary transform of the module 830 is generally a non-separable transform, which is only applied for the residual of intra-predicted CUs and may nonetheless also be bypassed. The forward secondary transform operates either on sixteen (16) samples (arranged as the upper-left 4×4 sub-block of the primary transform coefficients 828) or forty-eight (48) samples (arranged as three 4×4 sub-blocks in the upper-left 8×8 coefficients of the primary transform coefficients 828) to produce a set of secondary transform coefficients. The set of secondary transform coefficients may be fewer in number than the set of primary transform coefficients from which they are derived. Due to application of the secondary transform to only a set of coefficients adjacent to each other and including the DC coefficient, the secondary transform is referred to as a ‘low frequency non-separable secondary transform’ (LFNST). Such secondary transforms may be obtained through a training process and, due to their non-separable nature and trained origin, exploit additional redundancy in the residual signal not able to be captured by separable transforms such as variants of DCT and DST applied horizontally and vertically. Moreover, when the LFNST is applied, all remaining coefficients in the TB are zero, both in the primary transform domain and the secondary transform domain.

The quantisation parameter 892 is constant for a given TB and thus results in a uniform scaling for the production of residual coefficients in the primary transform domain for a TB. The quantisation parameter 892 may vary periodically with a signalled ‘delta quantisation parameter’. The delta quantisation parameter (delta QP) is signalled once for CUs contained within a given area, referred to as a ‘quantisation group’. If a CU is larger than the quantisation group size, delta QP is signalled once with one of the TBs of the CU. That is, the delta QP is signalled by the entropy encoder 838 once for the first quantisation group of the CU and not signalled for any subsequent quantisation groups of the CU. A non-uniform scaling is also possible by application of a ‘quantisation matrix’, whereby the scaling factor applied for each residual coefficient is derived from a combination of the quantisation parameter 892 and the corresponding entry in a scaling matrix. The scaling matrix may have a size that is smaller than the size of the TB, and when applied to the TB a nearest neighbour approach is used to provide scaling values for each residual coefficient from a scaling matrix smaller in size than the TB size. The residual coefficients 836 are supplied to the entropy encoder 838 for encoding in the bitstream 121. Typically, the residual coefficients of each TB with at least one significant residual coefficient of the TU are scanned to produce an ordered list of values, according to a scan pattern. The scan pattern generally scans the TB as a sequence of 4×4 ‘sub-blocks’, providing a regular scanning operation at the granularity of 4×4 sets of residual coefficients, with the arrangement of sub-blocks dependent on the size of the TB. The scan within each sub-block and the progression from one sub-block to the next typically follow a backward diagonal scan pattern. Additionally, the quantisation parameter 892 is encoded into the bitstream 121 using a delta QP syntax element, and a slice QP for the initial value in a given slice or subpicture and the secondary transform index 888 is encoded in the bitstream 121.

As described above, the video encoder 120 needs access to a frame representation corresponding to the decoded frame representation seen in the video decoder. Thus, the residual coefficients 836 are passed through an inverse secondary transform module 844, operating in accordance with the secondary transform index 888 to produce intermediate inverse transform coefficients, represented by an arrow 842. The intermediate inverse transform coefficients 842 are inverse quantised by a dequantiser module 840 according to the quantisation parameter 892 to produce inverse transform coefficients, represented by an arrow 846. The dequantiser module 840 may also perform an inverse non-uniform scaling of residual coefficients using a scaling list, corresponding to the forward scaling performed in the quantiser module 834. The inverse transform coefficients 846 are passed to an inverse primary transform module 848 to produce residual samples, represented by an arrow 850, of the TU.

The inverse primary transform module 848 applies DCT-2 transforms horizontally and vertically, constrained by the maximum available transform size as described with reference to the forward primary transform module 826. The types of inverse transform performed by the inverse secondary transform module 844 correspond with the types of forward transform performed by the forward secondary transform module 830. The types of inverse transform performed by the inverse primary transform module 848 correspond with the types of primary transform performed by the primary transform module 826. A summation module 852 adds the residual samples 850 and the PU 820 to produce reconstructed samples (indicated by the arrow 854) of the CU.

The reconstructed samples 854 are passed to a reference sample cache 856 and an in-loop filters module 868. The reference sample cache 856, typically implemented using static RAM on an ASIC to avoid costly off-chip memory access, provides minimal sample storage needed to satisfy the dependencies for generating intra-frame PBs for subsequent CUs in the frame. The minimal dependencies typically include a ‘line buffer’ of samples along the bottom of a row of CTUs, for use by the next row of CTUs and column buffering the extent of which is set by the height of the CTU. The reference sample cache 856 supplies reference samples (represented by an arrow 858) to a reference sample filter 860. The sample filter 860 applies a smoothing operation to produce filtered reference samples (indicated by an arrow 862). The filtered reference samples 862 are used by an intra-frame prediction module 864 to produce an intra-predicted block of samples, represented by an arrow 866. For each candidate intra prediction mode the intra-frame prediction module 864 produces a block of samples, that is 866. The block of samples 866 is generated by the module 864 using techniques such as DC, planar or angular intra prediction. The block of samples 866 may also be produced using a matrix-multiplication approach with neighbouring reference sample as input and a matrix selected from a set of matrices by the video encoder 120, with the selected matrix signalled in the bitstream 121 using an index to identify which matrix of the set of matrices is to be used by the video decoder 144.

The in-loop filters module 868 applies several filtering stages to the reconstructed samples 854. The filtering stages include a ‘deblocking filter’ (DBF) which applies smoothing aligned to the CU boundaries to reduce artefacts resulting from discontinuities. Another filtering stage present in the in-loop filters module 868 is an ‘adaptive loop filter’ (ALF), which applies a Wiener-based adaptive filter to further reduce distortion. A further available filtering stage in the in-loop filters module 868 is a ‘sample adaptive offset’ (SAO) filter. The SAO filter operates by firstly classifying reconstructed samples into one or multiple categories and, according to the allocated category, applying an offset at the sample level.

Filtered samples, represented by an arrow 870, are output from the in-loop filters module 868. The filtered samples 870 are stored in the frame buffer 872. The frame buffer 872 typically has the capacity to store several (for example, up to sixteen (16)) pictures and thus is stored in the memory 206. The frame buffer 872 is not typically stored using on-chip memory due to the large memory consumption required. As such, access to the frame buffer 872 is costly in terms of memory bandwidth. The frame buffer 872 provides reference frames (represented by an arrow 874) to a motion estimation module 876 and the motion compensation module 880.

The motion estimation module 876 estimates a number of ‘motion vectors’ (indicated as 878), each being a Cartesian spatial offset from the location of the present CB, referencing a block in one of the reference frames in the frame buffer 872. A filtered block of reference samples (represented as 882) is produced for each motion vector. The filtered reference samples 882 form further candidate modes available for potential selection by the mode selector 886. Moreover, for a given CU, the PU 820 may be formed using one reference block (‘uni-predicted’) or may be formed using two reference blocks (‘bi-predicted’). For the selected motion vector, the motion compensation module 880 produces the PB 820 in accordance with a filtering process supportive of sub-pixel accuracy in the motion vectors. As such, the motion estimation module 876 (which operates on many candidate motion vectors) may perform a simplified filtering process compared to that of the motion compensation module 880 (which operates on the selected candidate only) to achieve reduced computational complexity. When the video encoder 120 selects inter prediction for a CU the motion vector 878 is encoded into the bitstream 121. The video decoder 146, also referred to as a feature map decoder, is shown in FIG. 9. Although the video decoder 146 of FIG. 9 is an example of a versatile video coding (VVC) video decoding pipeline, other video codecs may also be used to perform the processing stages described herein. As shown in FIG. 9, the bitstream 143 is input to the video decoder 146. The bitstream 143 may be read from memory 206, the hard disk drive 210, a CD-ROM, a Blu-ray disk™ or other non-transitory computer readable storage medium. Alternatively, the bitstream 143 may be received from an external source such as a server connected to the communications network 220 or a radio-frequency receiver. The bitstream 143 contains encoded syntax elements representing the captured frame data to be decoded.

The bitstream 143 is input to an entropy decoder module 920. The entropy decoder module 920 extracts syntax elements from the bitstream 143 by decoding sequences of ‘bins’ and passes the values of the syntax elements to other modules in the video decoder 146. The entropy decoder module 920 uses variable-length and fixed length decoding to decode SPS, PPS or slice header an arithmetic decoding engine to decode syntax elements of the slice data as a sequence of one or more bins. Each bin may use one or more ‘contexts’, with a context describing probability levels to be used for coding a ‘one’ and a ‘zero’ value for the bin. Where multiple contexts are available for a given bin, a ‘context modelling’ or ‘context selection’ step is performed to choose one of the available contexts for decoding the bin.

The entropy decoder module 920 applies an arithmetic coding algorithm, for example ‘context adaptive binary arithmetic coding’ (CABAC), to decode syntax elements from the bitstream 143. The decoded syntax elements are used to reconstruct parameters within the video decoder 146. Parameters include residual coefficients (represented by an arrow 924), a quantisation parameter 974, a secondary transform index 970, and mode selection information such as an intra prediction mode (represented by an arrow 958). The mode selection information also includes information such as motion vectors, and the partitioning of each CTU into one or more CBs. Parameters are used to generate PBs, typically in combination with sample data from previously decoded CBs.

The residual coefficients 924 are passed to an inverse secondary transform module 936 where either a secondary transform is applied or no operation is performed (bypass) according to a secondary transform index. The inverse secondary transform module 936 produces reconstructed transform coefficients 932, that is primary transform domain coefficients, from secondary transform domain coefficients. The reconstructed transform coefficients 932 are input to a dequantiser module 928. The dequantiser module 928 performs inverse quantisation (or ‘scaling’) on the residual coefficients 932, that is, in the primary transform coefficient domain, to create reconstructed intermediate transform coefficients, represented by an arrow 940, according to the quantisation parameter 974. The dequantiser module 928 may also apply a scaling matrix to provide non-uniform dequantization within the TB, corresponding to operation of the dequantiser module 840. Should use of a non-uniform inverse quantisation matrix be indicated in the bitstream 143, the video decoder 144 reads a quantisation matrix from the bitstream 143 as a sequence of scaling factors and arranges the scaling factors into a matrix. The inverse scaling uses the quantisation matrix in combination with the quantisation parameter to create the reconstructed intermediate transform coefficients 940.

The reconstructed transform coefficients 940 are passed to an inverse primary transform module 944. The module 944 transforms the coefficients 940 from the frequency domain back to the spatial domain. The inverse primary transform module 944 applies inverse DCT-2 transforms horizontally and vertically, constrained by the maximum available transform size as described with reference to the forward primary transform module 826. The result of operation of the module 944 is a block of residual samples, represented by an arrow 948. The block of residual samples 948 is equal in size to the corresponding CB. The residual samples 948 are supplied to a summation module 950.

At the summation module 950 the residual samples 948 are added to a decoded PB (represented as 952) to produce a block of reconstructed samples, represented by an arrow 956. The reconstructed samples 956 are supplied to a reconstructed sample cache 960 and an in-loop filtering module 988. The in-loop filtering module 988 produces reconstructed blocks of frame samples, represented as 992. The frame samples 992 are written to a frame buffer 996.

The reconstructed sample cache 960 operates similarly to the reconstructed sample cache 856 of the video encoder 120. The reconstructed sample cache 960 provides storage for reconstructed samples needed to intra predict subsequent CBs without the memory 206 (for example, by using the data 232 instead, which is typically on-chip memory). Reference samples, represented by an arrow 964, are obtained from the reconstructed sample cache 960 and supplied to a reference sample filter 968 to produce filtered reference samples indicated by arrow 972. The filtered reference samples 972 are supplied to the intra-frame prediction module 976. The module 976 produces a block of intra-predicted samples, represented as 980, in accordance with the intra prediction mode parameter 958 signalled in the bitstream 143 and decoded by the entropy decoder 920. The intra prediction module 976 supports the modes of the module 864, including IBC and MIP. The block of samples 980 is generated using modes such as DC, planar or angular intra prediction.

When the prediction mode of a CB is indicated to use intra prediction in the bitstream 143, the intra-predicted samples 980 form the decoded PB 952 via a multiplexor module 984. Intra prediction produces a prediction block (PB) of samples, which is a block in one colour component, derived using ‘neighbouring samples’in the same colour component. The neighbouring samples are samples adjacent to the current block and by virtue of being preceding in the block decoding order have already been reconstructed. Where luma and chroma blocks are collocated, the luma and chroma blocks may use different intra prediction modes. However, the two chroma CBs share the same intra prediction mode.

When the prediction mode of the CB is indicated to be inter prediction in the bitstream 143, a motion compensation module 934 produces a block of inter-predicted samples, represented as 938. The block of inter-predicted samples 938 are produced using a motion vector, decoded from the bitstream 143 by the entropy decoder 920, and reference frame index to select and filter a block of samples 998 from the frame buffer 996. The block of samples 998 is obtained from a previously decoded frame stored in the frame buffer 996. For bi-prediction, two blocks of samples are produced and blended to produce samples for the decoded PB 952. The frame buffer 996 is populated with filtered block data 992 from the in-loop filtering module 988. As with the in-loop filtering module 868 of the video encoder 120, the in-loop filtering module 988 applies any of the DBF, the ALF and SAO filtering operations. Generally, the motion vector is applied to both the luma and chroma channels, although the filtering processes for sub-sample interpolation in the luma and chroma channel are different. Frames from the frame buffer 996 are output as decoded frames 162.

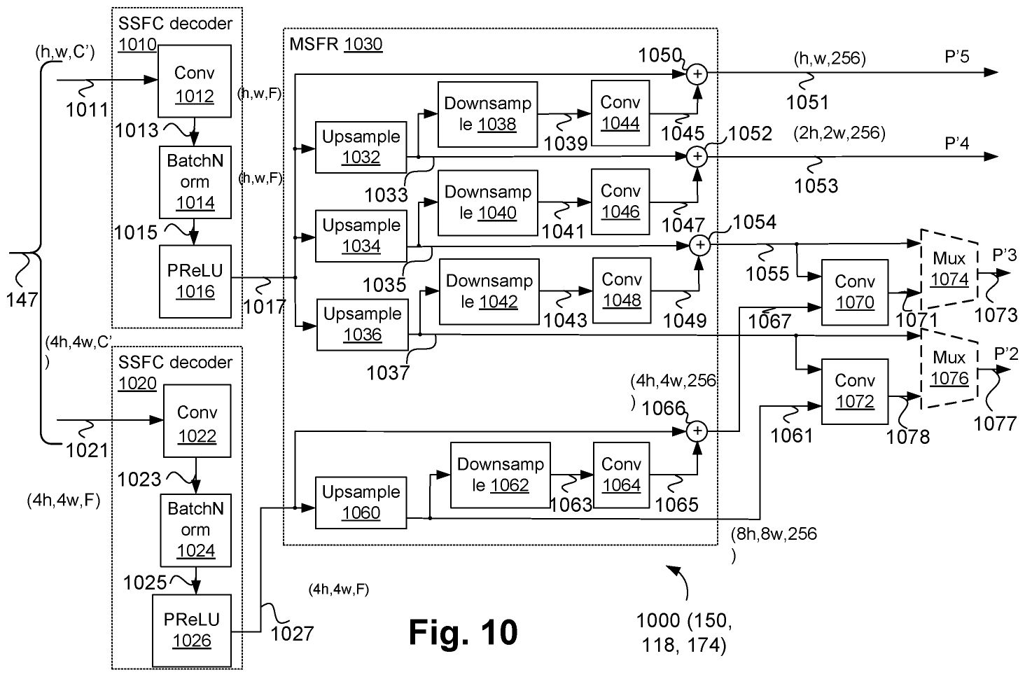

FIG. 10 is a schematic block diagram showing a cross-layer tensor inverse bottleneck decoder 1000, corresponding to the decoder 150 (and similarly decoders 118 and 174) for restoring tensor dimensionality after compression. FIG. 15 shows a method 1500 for restoring tensor dimensionality using the bottleneck decoder 150 of FIG. 10. The method 1500 may be implemented using apparatus such as a configured FPGA, an ASIC, or an ASSP. Alternatively, as described below, the method 1500 may be implemented by the destination device 140, as one or more software code modules of the application programs 233, under execution of the processor 205. The software code modules of the application programs 233 implementing the method 1500 may be resident, for example, in the hard disk drive 210 and/or the memory 206. The method 1500 is repeated for each frame of compressed data in the bitstream 123. The method 1500 may be stored on computer-readable storage medium and/or in the memory 206. The method 1500 provides a ‘switchable’ means to decode a bitstream containing a compressed representation of the entire FPN and, optionally, an additional compressed representation of a portion of the FPN, and to combine the two representations on the FPN (entire and additional portion) into a final decoded FPN tensors for provision to the CNN head 152.

The decoder 150 receives the tensors 147, as generated by operation of the video decoder 146 and the module 160 on the bitstream 143. The tensors 147 include tensors 1011 and 1021 as first and second units of information. Tensor 1021 corresponds to a decoded version of the tensor 537. Similarly, the tensor 1011 corresponds to a decoded version of the tensor 557. If the bitstream 143 is generated by operation of the first mode of the encoder 500, at least the tensor 1011 is decoded from the bitstream by the video decoder 146. A flag relating to mode operation may also be decoded. If the bitstream 143 is generated by operation of the first mode of the encoder 500, the tensor 1021 is also decoded by the video decoder 146. The method 1500 begins at a decode first bottleneck tensor step 1510.

At the step 1510, an SSFC decoder 1010 is implemented under execution of the processor 205. The SSFC decoder performs neural network layers to decompress the first decoded compressed tensor 1011 of the tensors 147 to produce a first decoded combined tensor 1017. A convolutional layer 1012 receives the tensor 1011 having C′=64 channels and outputs a tensor 1013 having F=256 channels. The tensor 1013 is passed to a batch normalisation layer 1014. The batch normalisation layer outputs a tensor 1015. The tensor 1015 is passed to a parameterised leaky rectified linear (PReLU) layer 1016. The PReLU layer 1016 outputs the tensor 1017. The tensor 1017 is passed to an MSFR module 1030, which generates tensors 1051, 1053, 1055, and 1037, forming a ‘base layer’ of decoded FPN layers. The base layer provides a lower degree of fidelity than present when additional ‘enhancement layer’ decoded FPN layers are included. Upsampling modules 1032, 1034, and 1036 receive the tensor 1017 and perform an interpolation at 2×, 4×, and 8× scale to produce the tensors 1033, 1035, and 1037, respectively. For example, the tensor 1033 has twice the width and height of tensor 1017.

The tensor 1037 forms one output from the MSFR module 1030 and is passed to a downsample module 1042. The downsample module 1042 downsamples the tensor 1037 by a factor of two horizontally and vertically to produce a tensor 1043 having the same dimensionality as the tensor 1035. The tensor 1043 is provided to a convolution layer 1048 which outputs a tensor 1049. A summation module 1054 adds the tensors 1035 and 1049 to produce the tensor 1055 as an output of the MSFR module 1030. A downsample module 1040 downsamples the tensor 1035 by a factor of two horizontally and vertically to produce a tensor 1041 having the same dimensionality as the tensor 1033. The tensor 1041 is provided to a convolution layer 1046 which outputs a tensor 1047. A summation module 1052 adds the tensors 1033 and 1047 to produce the tensor 1053 as an output of the MSFR module 1030. A downsample module 1038 downsamples the tensor 1033 by a factor of two horizontally and vertically to produce a tensor 1039 having the same dimensionality as the tensor 1017. The tensor 1039 is provided to a convolution layer 1044 which outputs a tensor 1045. A summation module 1050 adds the tensors 1017 and 1045 to produce the tensor 1051 as an output of the MSFR module 1030.

The step 1510 generates the tensors 1051, 1053, 1055, and 1037. The tensors 1051, 1053, 1055, and 1037 form a hierarchical representation of the image frame and can be considered to include a first tensor (for example, 1037 P′2 or 1055 P′3) and a second tensor (for example, 1053 P′4 or 1051 P′5), feature maps in the first tensor having a larger spatial resolution than feature maps of the second tensor. Control in the processor 205 progresses from the step 1160 to a decode second bottleneck tensor present indication step 1520.

At the step 1520 the entropy decoder 920, under execution of the processor 205, decodes an indication from the bitstream 123 indicating whether the bitstream 123 includes a second bottleneck tensor or not. Presence of the second bottleneck tensor may be determined from the decoded presence flag 751 obtained from the SEI message 744. Control in the processor 205 progresses from the step 1520 to a second bottleneck tensor present test step 1530.

At the step 1530, the application 233 executes to determine if the decoding of the bitstream 123 at step 1520 indicated inclusion of the second bottleneck tensor. If the presence flag 751 indicated a second bottleneck tensor was encoded (“PRESENT” at step 1530) control in the processor 205 progresses from the step 1530 to a decode second bottleneck tensor step 1540. Otherwise if presence of the second bottleneck tensor is not determined (“ABSENT” at step 1530) control in the processor 205 progresses to a combined first and second tensors step 1550. The decoder 1000 can be considered to operate in a first (base) mode of operation, when the second bottleneck tensor is determined not to be present (“ABSENT” at 1530). The decoder 1000 can be considered to operate in a second (enhanced) mode of operation, when the second bottleneck tensor is determined not to present (“PRESENT” at 1530).

At the step 1540, an SSFC decoder 1020 is implemented under execution of the processor 205. The SSFC decoder 1020 performs neural network layers to decompress the second decoded compressed tensor 1021 of the tensors 147 to produce a second decoded combined tensor 1027.

A convolutional layer 1022 receives the tensor 1021 having C′=64 channels and outputs a tensor 1023 having F=256 channels. The tensor 1023 is passed to a batch normalisation layer 1024. The batch normalisation layer 1024 outputs a tensor 1025. The tensor 1025 is passed to a PReLU layer 1026. The PReLU layer 1026 outputs the tensor 1027.

The MSFR module 1030 generates decoded tensors 1061 and 1067 using an upsampling module 1060, a downsampling module 1062, a convolutional layer 1064 and a summation module 1066. The tensor 1027 is passed to upsampling module 1060. The upsampling module 1060 performs an interpolation to produce tensor 1061 having twice the width and height of tensor 1027. The tensor 1061 is output from the MSFR module 1030 and passed to a downsample module 1062. The downsample module 1062 downsamples the tensor 1061 to produce a tensor 1063 having the same dimensionality as the tensor 1027. The tensor 1063 is provided to the convolution layer 1064, with stride of one, which outputs a tensor 1065. The summation module 1066 adds the tensors 1065 and 1027 to produce the tensor 1067, which is output from the MSFR module 1030. Control in the processor 205 progresses from the step 1540 to the step 1550.

At the step 1550 decoded FPN tensors P′2-P′5, i.e., 1051, 1053, 1073, and 1077 are produced. Tensors 1051 and 1053 from the base-layer portion of the MSFR module 1030 are ready to be passed to the CNN head 150. The tensors 1073 and 1077 are determined at the step 1550 from the tensors 1055 and 1037 and, optionally, from tensors 1071 and 1078. If the determination was made not to use an enhancement layer, i.e., to omit the second bottleneck tensor, multiplexors 1074 and 1076 output tensors 1055 and 1037 as tensors 1073 and 1077, respectively. When the second bottleneck tensor is omitted, the CNN head is provided with tensors for all FPN layers allowing the task to be performed, however with reduced task performance due to the lower spatial fidelity in the higher-resolution layers, for example, P2 and P3. The reduced task performance from using the base layer only tends to limit the maximum achievable mAP for instance segmentation where near-lossless compression reached in the video encoder 120 and loss within the bottleneck encoder and decoder minimised. Presence of the enhancement layer (in addition to the base layer) can increase the maximum achievable mAP to almost that achieved were the neural network run as a single operation, i.e., without separation into two portions.

If the determination to include the enhancement layer was made (“PRESENT” at step 1030), then convolutions 1070 and 1072 are performed. The convolution 1070 take tensors 1055 and 1067, concatenated along the channel dimension, as input and produces output tensor 1071. The convolution 1072 takes tensors 1037 and 1061, concatenated along the channel dimension, as input and produces output tensor 1078. Multiplexors 1074 and 1076 pass along tensors 1071 and 1078 as tensors 1073 and 1077. When the enhancement layer is included, output tensors 1071 and 1073, for P′2 and P′3, have increased spatial fidelity which benefits tasks such as instance segmentation.

Accordingly, in the second mode, a plurality of tensors is derived that forms at least part of the hierarchical representation of the image data. The tensors are derived from the tensors 1021 and at least part of the tensors decoded at step 1510 relating to at least the first tensor (for example, 1051 and 1053).

In an arrangement of the method 1500 the multiplexors 1074 and 1076 are omitted and the convolutions 1072 and 1074 are initialised according to the determination to use the enhancement layer or not. When the enhancement layer is in use, pretrained weights are used to initialise the convolutions 1072 and 1074. Accordingly, in the second (enhancement) mode, the convolutional layers receive tensors for the P′2 and P′3 (each one being an example of the first tensor) tensors derived from each of the first and second units of information. When the enhancement layer is not in use (in the first mode), the convolutions 1072 and 1074 are initialised such that convolutional weights corresponding to input tensors 1055 and 1037 form identity matrices and weights corresponding to input tensors 1061 and 1067 are zeroed out.

Application of an identity matrix by the convolutional modules 1072 and 1074 to input tensors 1055 and 1037 result in tensors 1055 and 1037 being output as 1071 and 1078, respectively, with input tensors 1061 and 1067 making no contribution to the output due to their corresponding weights being zeroed out.

The method 1500 terminates on implementing the step 1550, having produced decoded FPN ready for processing by the CNN head 150. The method 1500 is re-invoked for each frame of video data encoded in the bitstream 123.

Operation of the bottleneck encoder 116 and the bottleneck decoder 150 with base layer and enhancement layer representations of the FPN layer tensors provides a form of quality scalability. To ensure intended operation of the enhancement layer as a ‘delta’ to improve fidelity of the decoded FPN tensors 119 or 151 with respect to FPN tensors 115 emanating from the backbone 114, trainable layers in the bottleneck encoder and decoder associated with the base layer must be trained initially, with the enhancement layer inactive. The SE module 526, the convolution 528, the SSFC encoder 550, the SSFC decoder 1010, the convolutions 1044, 1046, and 1048 are trained to provide base-layer capability of the bottleneck encoder and decoder. To train the enhancement layer, modules associated with the base layer in the bottleneck encoder and decoder are fixed and modules associated with the enhancement layer are set as trainable. Then, the enhancement layer modules (SE module 516, convolution 518, SSFC encoder 530, SSFC decoder 1020, convolution 1064) and two convolutions 1070 and 1072, acting to merge base-layer and enhancement-layer tensors together, learn to provide a ‘delta’ improvement in performance on top of performance achieved using just the base layer.

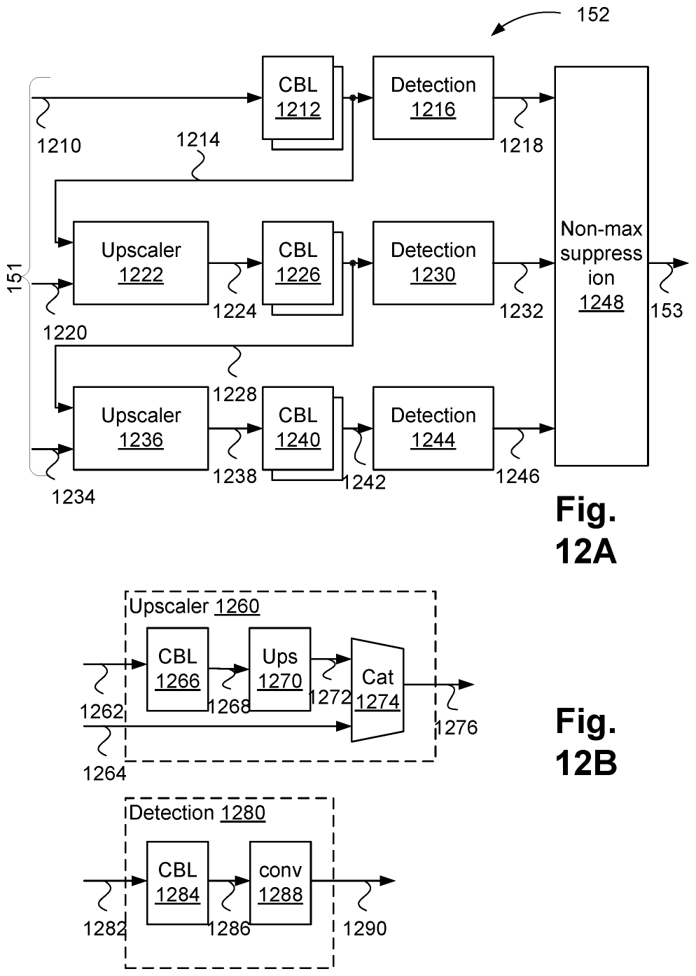

FIG. 12A is a schematic block diagrams showing a head portion 152 of a CNN for object detection. Depending on the task to be performed in the destination device 140, different networks may be substituted for the CNN head 152. Incoming tensors 151 are separated into the tensor of each layer (i.e., tensors 1210, 1220, and 1234). The tensor 1210 is passed to a CBL module 1212 to produce tensor 1214. The tensor 1214 is passed to a detection module 1216 and an upscaler module 1222. The detection module 1216 operates to detect bounding boxes 1218. The bounding boxes 1218 are in the form of a detection tensor. The bounding boxes 1218 are passed to a non-maximum suppression (NMS) module 1248. The NMS module 1248 selects one of multiple inputs generated by detection modules to produce a detection result 153. To produce bounding boxes addressing co-ordinates in the original video data 113, prior to resizing for the backbone portion of the network 114, scaling by the original video width and height is performed. The upscaler module 1222 produces an upscaled tensor 1224 scaled by original video width and height. The upscaled tensor 1224 is passed to a CBL module 1226. The CBL module 1226 produces tensor 1228 as output. The tensor 1228 is passed to a detection module 1230 and an upscaler module 1236. The detection module 1230 operates in a similar manner to the detection module 1216 and produces a detection tensor 1232. The detection tensor 1232 is supplied to the NMS module 1248.

The upscaler module 1236 operates in the same manner as the module 1260 and outputs an upscaled tensor 1238. The upscaled tensor 1238 is passed to a CBL module 1240. The CBL module 1240 operates in the same manner as the modules 1212 and 1226 to output a tensor 1242 to a detection module 1244. The detection module 1244 operates in a similar manner to the detection module 1216 and produces a detection tensor 1246. The detection tensor 1246 is supplied to the NMS module 1248.

The CBL modules 1212, 1226, and 1240 each contain a concatenation of five CBL modules, each CBL module as described with reference to FIG. 3D. The upscaler modules 1222 and 1236 are each instances of an upscaler module 1260 as shown in FIG. 12B.

The upscaler module 1260 accepts a tensor 1262 and a tensor 1264 as inputs. The tensor 1262 is passed to a CBL module 1266 to produce a tensor 1268. The tensor 1268 is passed to an upsampler 1270 to produce an upsampled tensor 1272, using nearest-neighbour interpolation or other various methods. A concatenation module 1274 produces a tensor 1276 by concatenating the upsampled tensor 1272 with the input tensor 1264.

The detection modules 1216, 1230, and 1244 are instances of a detection module 1280 as shown in FIG. 12C. The detection module 1260 receives a tensor 1282, which is passed to a CBL module 1284 to produce a tensor 1286. The tensor 1286 is passed to a convolution module 1288, which implements a detection kernel. A detection kernel a 1×1 kernel applied to produce the output on feature maps at the three layers. The detection kernel is 1×1×(B×(5+C) ), where B is the number of bounding boxes a particular cell can predict, typically three (3), and C is the number of classes, which may be eighty (80), resulting in a kernel size of two-hundred and fifty five (255) detection attributes. The module 1288 outputs tensor 1290. The constant “5” represents four boundary box attributes (box centre x, y and size scale x, y) and one object confidence level (“objectness”). The result of a detection kernel has the same spatial dimensions as the input feature map, but the depth of the output corresponds to the detection attributes. The detection kernel is applied at each layer, typically three layers, resulting in a large number of candidate bounding boxes. A process of non-maximum suppression is applied by the NMS module 1048 to the resulting bounding boxes to discard redundant boxes, such as overlapping predictions at similar scale, resulting in a final set of bounding boxes as output for object detection.

FIG. 13 is a schematic block diagram showing an alternative head portion 1300 of a CNN, as can be implemented for the module 152. The head portion 1300 forms part of an overall network known as ‘Faster RCNN’ and includes a feature network (i.e., backbone portion 400), a region proposal network, and a detection network. Input to the head portion 1300 are the tensors 151. The tensors 151 include P2-P6 layer tensors 1310, 1312, 1314, 1316, and 1318 respectively. The P2-P6 tensors 1310, 1312, 1314, 1316, and 1318 are input to a region proposal network (RPN) head module 1320. The RPN head module 1320 performs a convolution on the input tensors, producing an intermediate tensor. The intermediate tensor is fed into two subsequent sibling layers in the module 1320, one for classifications and one for bounding box, or ‘region of interest’ (ROI), regression, generating an output of classification and bounding boxes 1322. The classification and bounding boxes 1322 are passed to an NMS module 1324. The NMS module prunes out redundant bounding boxes by removing overlapping boxes with a lower score to produce pruned bounding boxes 1326.

The bounding boxes 1326 are passed to a region of interest (ROI) align module 1328, or ‘RoIAlign’ stage. The ROI align module 1328 also receives the tensors P2 to P6 and produces fixed-size feature maps from various input size maps using bilinear interpolation operations. In the operations performed by the ROI align module 1328 a subsampling results from bilinear interpolation of a number of sub-regions, as 3×3 sub-regions, in a received regions of interest to produce output regions of interest as one output value in the output tensor.

In an arrangement of the CNN backbone 400 and the CNN head 1300, the ‘P6’ layer tensor 429 is omitted from the output tensors 115 and in the CNN head 1300, the P6 input tensor 1318 is produced by performing a ‘Maxpool’ operation with stride equal to two on the P5 tensor 1316. Since the P6 layer can be reconstructed from the P5 layer, there is no need to separately encode and decode the P6 layer as an explicit FPN layer among the first set of tensors or the second set of tensors.

Input to the ROI align module 1328 are the P2-P5 feature maps 1310, 1312, 1314, and 1316 (corresponding to 1077, 1073, 1053 and 1051 of FIG. 10, respectively), and region of interest proposals 1326. Each proposal (ROI) from 1326 is associated with a portion of the feature maps (1310-1316) to produce a fixed-size map. The fixed-size map is of a size independent of the underlying portion of the feature map 1310-1316. One of the feature maps 1310-1316 is selected such that the resulting cropped map has sufficient detail, for example, according to the following rule: floor(4+log2(sqrt(box_area)/224)), where 224 is the canonical box size. The ROI align module 1328 thus crops incoming feature maps according to the proposals 1326 producing a tensor 1330. The tensor 1330 is fed into a fully connected (FC) neural network head 1332. The FC head 1332 performs two fully connected layers to produce class score and bounding box predictor delta tensor 1334. The class score is generally an 80-element tensor, each element corresponding to a prediction score for the corresponding object category. The bounding box prediction deltas tensor is an 80×4=320 element tensor, containing bounding boxes for the corresponding object categories. Final processing is performed by an output layers module 1336, receiving the tensor 1334 and performing a filtering operation to produce a filtered tensor 1338. The final processing encodes one or more bounding boxes for each location in the tensor for each FPN layer, with an indication on the object classification and the confidence that the bounding box does correspond to an object (the ‘objectness’ value). Low-scoring (low classification) objects are removed from further consideration. A non-maximum suppression module 1340 receives the filtered tensor 1334 and removes overlapping bounding boxes encoded in the received tensors by removing the overlapped box with a lower classification score, resulting in an inference output tensor 151.

In an arrangement of the source device 110 and the destination device 140 the backbone 114 and the head 152 are omitted and the bottleneck encoder and decoders, i.e., 170, 174, 116, 118, and 150, are operable as end-to-end learned image compression and decompression neural networks, taking an image frame as input to the encoding stage and outputting a decoded image frame from the decoding stage. The end-to-end learned image compression networks are trained during operation upon necessity to adapt to changing input frame data. This enables a potentially smaller network to be used that is dynamically updated to match the particular video or images being compressed rather than relying on a pretrained network that needs to have been trained on a wide variety of source material to achieve consistent performance. Examples of different types of source material for which adaptation might be needed includes screen content, camera captured content (under a variety of lighting and other conditions), rendered content and the like. The metric for measuring performance of the bottleneck encoder and encoder may be different to MSE, for example MS-SSIM may be produced at the steps 630 and 645. A performance metric of MS-SSIM may be useful where the system 100 is operable to provide a trainable end-to-end learned image compression.

Initial weights for the bottleneck encoders and decoders, i.e., 170, 174, 116, 118, and 150, may be derived by performing training using a dataset and ground truth suitable for the original task network, i.e., suitable for the network formed by the backbone 114 and the head 152. Training using such a dataset may be performed with network weights of the backbone 114 and the head 152 fixed and network weights of the inserted bottleneck encoder and decoder allowed to be updated. Such initial weights may be used in the source device 110 and the destination device 140 prior to any refinement training. Such initial weights may exhibit a trend that, during training, MSE, when measured on a per-channel basis, varied between channels. Variance of MSE between channels under a loss function corresponding to final task performance indicates a relative contribution each channel makes to the final task result. In an arrangement of the source device 110 the modules 178 and 180 produces a per-channel weights MSE, such that channels making less contribution to final task performance are ‘derated’ or scaled-down in terms of their contribution to final MSE. Per-channel (or ‘channel-wise’) scaling of MSE based on a predetermined weighting enables refinement training to adapt without over-allocating importance to preserving channels making relatively less contribution to the final task score.

In an arrangement of the bottleneck encoder and decoder modules 116, 120, 170, 174, and 150 operate to merge tensors of all FPN layers into a single tensor having dimensions set according to the smallest resolution tensor of the FPN tensors for one image. In other words, with reference to FIGS. 5 and 10, one MSFF module 510 fuses tensors for all FPN layer tensors, e.g., 502, 503, 504, and 505, together into a single tensor and the MSFR module 1030 reconstructs tensors for all FPN layers, e.g., 1077, 1073, 1053, and 1051. Additionally, if required, the switch 570 can be closed, such that additional data for the P2 and P3 tensors can be encoded as described in relation to FIG. 5 and decoded as described for FIG. 10 in relation to the SSFC decoder 1020 in association with the MSFR 1030.

In an arrangement of the source device 110 multiple sets of trained weights are available, for example weights optimised for screen content, camera-captured content, rendered content. The source device 110 is operable to select the optimal set of weights among the available predetermined weights and signal the selected weights to the destination device 140. The source device 110 may ‘test’ each set of weights in the modules 170 and 174 to device which set should be used. A change in content type of the frame data 113 may cause a reduction in performance as measured by the module 182 that prompts a re-evaluation of which set of predetermined weights should be used.

In an arrangement of the source device 110, the modules 170 and 174 are operable to train weights associated with the enhancement layer (the second unit of information) and the convolutions 1070 and 1072, but not the weights associated with the base layer (the first unit of information). Signalling associated with weight update in the bitstream 123 supports indicating the enhancement layer only is to be updated when the determination to update weights is made.

In another arrangement of the source device 110, the modules 170 and 174 are operable to train the base layer and the enhancement layer as separate training stages. When the base layer is trained the enhancement layer is disabled, allowing optimal base-layer weights to be derived. Once updates weights for the base layer are determined in the source device 110 and communicated to the destination device 140, the enhancement layer requires retraining before the enhancement layer can be enabled. The retaining is required since the enhancement layer operates in combination with the base layer, which has been retrained. Once enhancement layer weights have been trained for operation on the new base layer, the enhancement layer weights must be communicated to the destination device 140 before the enhancement layer can be re-enabled for compression of the tensors 115.

In arrangements where the base layer and the enhancement layer are separately trained, additional weight update flags (i.e., flags in addition to the weight update flag 750) are used to indicate for which layer a weight update is to be performed. The weights 752 include weights for the indicated layers.

In an arrangement of the system 100, each feature map of the enhancement layer 537 is represented as a set of coefficients applicable to a set of basis vectors. The basis vectors are derived from the enhancement layer using a principal component analysis (PCA) method, such a singular value decomposition (SVD). When a PCA method is in use, the region 716 of the frame 700 includes basis vectors and coefficients, with one coefficient per basis vector per feature map of the enhancement layer 537. In the source device 110, transformation from the enhancement layer 537 into coefficients is performed using a dot product with the basis vectors. In the destination device 140, transformation from coefficients back to the reconstructed enhancement layer 1021 is performed with a dot product of coefficients and the basis vectors. The PCA method may be applied to both the base layer and the enhancement layer, resulting in two sets of basis vectors and two sets of coefficients. Operation of the PCA encoder and PCA decoder is described in detail in document ‘[VCM Track 1] Tensor compression using VVC’, ISO/IEC JTC 1/SC 29/WG 2 document m59591. The PCA method can be applied to both the base layer and the enhancement layer, with separate basis vectors and coefficients produced for each layer. The PCA method can be applied just to the enhancement layer, with basis vectors and coefficients produced just for this layer while all feature maps of the base layer are packed directly into the frame 700.

In a case where separate bottleneck encoders are applied to different non-overlapping sets of tensors of the FPN layer, the PCA method can be applied independently to any of all of the resulting compressed tensors. Where the PCA encoder is in use, input tensors to the PCA encoder are received from the output of the SSFC encoders 550 and 530, i.e., from the tensors 557 and 537, which are the output of the tanh modules 556 and 536 (if present) or the output of the batch normalisation modules 554 and 534. Output basis vectors, coefficients, and mean feature maps are forwarded for quantisation and packing into the frame 700. Where the PCA decoders are in use, input basis vectors, coefficients, and mean feature maps are obtained from the packed frame 700 and supplied to each PCA decoder, which outputs tensors 1011 and 1021 for use by the SSFC decoders 1010 and 1020, respectively. In an arrangement of the system 100, where the PCA encoders and decoders are in use, the batch normalisations 554 and 534 are deferred until after the PCA decoder, i.e., the modules 554 and 534 are omitted from the SSFC encoders 550 and 530 and performed after the PCA decoders in the SSFC decoders 1010 and 1020.

In an arrangement of the system 100, the source device 140 implements a MaskRCNN backbone regardless of whether the task to perform is object detection or instance segmentation and is initialised with pretrained weights for the MaskRCNN network. When performing object detection the destination device 140 implements a FasterRCNN head at 152 and is initialised with pretrained weights for a FasterRCNN network. If a FasterRCNN head is implemented, there is a need for the bottleneck decoder 150 to act as an interface between feature maps generated from the MaskRCNN backbone but supplied to the FasterRCNN head. The bottleneck encoder 116 remains optimised in terms of training for the MaskRCNN backbone and head, as at the time of performing encoding it may not be known what the head network will be performed. To prepare initial weights for the bottleneck decoder 150, a ‘hybrid’ training process may be performed. The hybrid training process involves instantiating the FasterRCNN network with the backbone initialised with MaskRCNN weights while the head is initialised with FasterRCNN weights. The MSFC encoder 116 is initialised with weights corresponding to a MaskRCNN training of MSFC (the bottleneck encoder and decoder). Then, only the bottleneck decoder 150 is set to trainable and all other network layers are set to fixed. A training operation is undertaken, which trains the bottleneck decoder to not only decode the compressed FPN tensors but also to adapt the resulting feature maps to match the expected input to the FasterRCNN head, resulting in minimised loss. As a result of the training, the bottleneck decoder 150 provides adaptation between the MaskRCNN backbone and the FasterRCNN head, with the bottleneck encoder 16 remaining optimised for the more capable network (i.e., MaskRCNN). When the bottleneck decoder 150 is initialised with weights trained for the ‘hybrid’ system of operation (MaskRCNN backbone with FasterRCNN head) the resulting bitstreams from the source device 110 are suitable both for object detection and instance segmentation at the time of their generation, that is, the same bitstream can be later used for both tasks without any transcoding or other operation. When a single bitstream generated by the source device 110 may serve to provide tensors to different neural network heads (provided the different neural networks corresponding to each neural network head share the same backbone topology and dimensionality) the source device 110 is said to support a ‘shared backbone’ mode of operation.

In another arrangement of the system 100, the C′ channel count for the SSFC encoder 530 and SSFC decoder 1020, i.e., the enhancement layer, is decreased compared to the C′ channel count for the SSFC encoder 550 and the SSFC decoder 1010 respectively, i.e., the base layer. The enhancement layer may use a C′ value of 32. Such arrangement have fewer of the larger sized feature maps, i.e., 710 to be packed into the frame 700. The ability to retrain the bottleneck encoder and bottleneck decoder applied to the enhancement layer permits fewer channels to be used to encode enhancement detail present in the P2 and P3 layers, adapting to changing statistics encountered across the full channel count of the applicable tensors (i.e., across the 256 channels of the P2 and P3 FPN layers).

### INDUSTRIAL APPLICABILITY

The arrangements described are applicable to the computer and data processing industries and particularly for the digital signal processing for the encoding and decoding of signals such as video and image signals, achieving high compression efficiency.

The arrangements described in relation to weight encoding in FIG. 1 provide a system capable of adapting to the dynamically changing statistics of incoming video data by undergoing a refinement training process from time to time, as deemed necessary by ongoing monitoring of the performance of the in-use bottleneck encoder and decoder. Upon determining refined weights offering improved performance, the actively used weights in the encoder and decoder are updated to use the refined weights, maintaining operation during the training process. Using ongoing monitoring of performance allows training of the MFSC unit 116 and the MFSC decoding unit 150 to be implemented based on changes in data input, or based on specific data type inputs during inference operation. Accordingly, the feature compression operations can be tuned or updated without requiring separate, off-system training for specific image types (such as natural or computer-generated images) or scenarios.

The arrangements described in relation to FIGS. 5 and 10, as described in relation to FIGS. 14 and 15, allow flexible operation between high performance and lower performance requirements. Different architectures are not needed for each system, rather a flexibility is provided which does not require loading different networks.

The foregoing describes only some embodiments of the present invention, and modifications and/or changes can be made thereto without departing from the scope and spirit of the invention, the embodiments being illustrative and not restrictive.

1. A method of encoding, the method comprising:
performing data compression for data related to an image, the data compression using a neural network associated with a first set of weights;
determining whether a set of weights for the data compression is to be changed; and
encoding first information indicating whether the set of weights is to be changed, based on the determination,
wherein, if it is determined that the set of weights for the data compression is to be changed, the method further comprises:
changing association of the neural network used in the data compression to a second set of weights from the first set of weights;
encoding second information indicating the second set of weights; and
encoding the data in which the data compression is performed using the neural network with the associated second set of weights.

2. The method according to claim 1, wherein the data compression includes multi-scale feature compression MSFC processing using the neural network.

3. The method according to claim 1, wherein an input to the data compression is at least one tensor in which neural network processing for a machine task is partially performed.

4. The method according to claim 1, wherein the second information represents a delta between the first set of weights and the second set of weights.

5. The method according to claim 1, further comprising:
acquiring a first value for evaluating data compression using the neural network with the first set of weights; and
acquiring a second value for evaluating data compression using the neural network with the second set of weights,
wherein, whether a set of weights for the data compression is changed is determined, based on a result of comparison of the first value and the second value.

6. The method according to claim 5, wherein the first and second values are values of MSE (Mean Square Error).

7. The method according to claim 5, wherein the first value is acquired using a tensor input to the data compression and a tensor after the data compression using the neural network with the first set of weights.

8. A method of decoding, the method comprising:
performing decoding processing to decode data related to an image from encoded data in which data compression is performed, the decoding performed using a neural network associated with a first set of weights; and
decoding first information indicating whether a set of weights for the decoding processing is to be changed,
wherein, if the first information indicates that the set of weights for the decoding processing is to be changed, the method further comprises:
decoding second information indicating a second set of weights; and
changing the association of the neural network used in the decoding processing to the second set of weights from the first set of weights.

9. The method according to claim 8, wherein the decoding processing including multi-scale feature compression (MSFC) processing using the neural network.

10. The method according to claim 8, wherein the encoded data includes data of a tensor in which neural network processing for a machine task is partially performed.

11. The method according to claim 10,
the method further comprising performing a remaining portion of the neural network processing for a machine task.

12. The method according to claim 8, wherein the second information represents delta between the first set of weights and the second set of weights.

13. A non-transitory computer-readable storage medium which stores a program for executing a method of encoding, the method comprising:
performing data compression for data related to an image, the data compression using a neural network associated with a first set of weights;
determining whether a set of weights for the data compression is to be changed; and
encoding first information indicating whether the set of weights is to be changed, based on the determination,
wherein, if it is determined that the set of weights for the data compression is to be changed, the method further comprises:
changing association of the neural network used in the data compression to a second set of weights from the first set of weights;
encoding second information indicating the second set of weights; and
encoding the data in which the data compression is performed using the neural network with the associated second set of weights.

14. An encoder configured to:
perform data compression for data related to an image, the data compression using a neural network associated with a first set of weights;
determine whether a set of weights for the data compression is to be changed; and
encode first information indicating whether the set of weights is to be changed, based on the determination,
wherein, if it is determined that the set of weights for the data compression is to be changed, the encoder is further configured to:
change association of the neural network used in the data compression to a second set of weights from the first set of weights;
encode second information indicating the second set of weights; and
encode the data in which the data compression is performed using the neural network with the associated second set of weights.

15. A system comprising:
a memory; and
a processor, wherein the processor is configured to execute code stored on the memory for implementing a method comprising:
performing data compression for data related to an image, the data compression using a neural network associated with a first set of weights;
determining whether a set of weights for the data compression is to be changed; and
encoding first information indicating whether the set of weights is to be changed, based on the determination,
wherein, if it is determined that the set of weights for the data compression is to be changed, the method further comprises:
changing association of the neural network used in the data compression to a second set of weights from the first set of weights;
encoding second information indicating the second set of weights; and
encoding the data in which the data compression is performed using the neural network with the associated second set of weights.

16. A non-transitory computer-readable storage medium which stores a program for executing a method of decoding, the method comprising:
performing decoding processing to decode data related to an image from encoded data in which data compression is performed, the decoding performed using a neural network associated with a first set of weights; and
decoding first information indicating whether a set of weights for the decoding processing is to be changed,
wherein, if the first information indicates that the set of weights for the decoding processing is to be changed, the method further comprises:
decoding second information indicating a second set of weights; and
changing the association of the neural network used in the decoding processing to the second set of weights from the first set of weights.

17. A decoder configured to:
perform decoding processing to decode data related to an image from encoded data in which data compression is performed, the decoding performed using a neural network associated with a first set of weights; and
decode first information indicating whether a set of weights for the decoding processing is to be changed,
wherein, if the first information indicates that the set of weights for the decoding processing is to be changed, the decoder is configured to:
decode second information indicating a second set of weights; and
change the association of the neural network used in the decoding processing to the second set of weights from the first set of weights.

18. A system comprising:
a memory; and
a processor, wherein the processor is configured to execute code stored on the memory for implementing a method comprising:
performing decoding processing to decode data related to an image from encoded data in which data compression is performed, the decoding performed using a neural network associated with a first set of weights; and
decoding first information indicating whether a set of weights for the decoding processing is to be changed,
wherein, if the first information indicates that the set of weights for the decoding processing is to be changed, the method further comprises:
decoding second information indicating a second set of weights; and
changing the association of the neural network used in the decoding processing to the second set of weights from the first set of weights.
